(19) United States
(12) Patent Application Publication
(10) Pub. No.: US 2026/0281379 A1
(43) Pub. Date: Sep. 17, 2026

(54) Asymmetrically-powered Neural Image Compression with Shallow Decoders

(71) Applicant: The Regents of the University of California, Oakland, CA (US)

(72) Inventors: Yibo Yang, Irvine, CA (US); Stephan Mandt, Venice, CA (US)

(21) Appl. No.: 19/168,290

(22) PCT Filed: Apr. 1, 2024
(86) PCT No.: PCT/US2024/022498

§ 371 Date: Sep. 23, 2025

Related U.S. Application Data
(60) Provisional application No. 63/456,573, filed on Apr. 3, 2023.

(51) Int. Cl. H04N 19/156; H04N 19/147; H04N 19/176; H04N 19/42; H04N 19/60

(52) U.S. Cl. CPC H04N 19/156; H04N 19/147; H04N 19/176; H04N 19/42; H04N 19/60

(57) ABSTRACT

Asymmetrically-powered neural image compression with shallow decoders are provided. In one embodiments, a method for an asymmetrically-powered neural image compression with shallow decoders is provided, the method comprising: determining an asymmetric computation budget between an encoding process and a decoding process, wherein the asymmetric computation budget comprises an encoding computation budget that is greater than a decoding computation budget; performing the encoding process using an encoder, wherein the encoding process comprises generating encoded data from a source data using an analysis transform; and performing the decoding process using a shallow decoder, wherein the decoding process comprises generating decoded data from the encoded data using a synthesis transform.

### CROSS-REFERENCE TO RELATED APPLICATION

The current application claims priority to U.S. Provisional Patent Application No. 63/456,573, filed on Apr. 3, 2023, the disclosure of which is incorporated herein by reference.

### FIELD OF THE INVENTION

The present invention generally relates to data compression and more specifically to machine-learning based image compression.

### BACKGROUND

Data compression, source coding, or bit-rate reduction may be described as a process of encoding information using fewer bits than an original representation. Generally, an encoder may perform compression and a decoder may perform decompression, which may be a reversal of the compression process to retrieve the original representation.

Typically, particular data compression processes may be either lossy or lossless. Lossy compression may result in some loss of information, where the reduction of bits is typically achieved by removing unnecessary or less important information. In contrast, lossless compression results in no loss of information, where reduction of bits may be provided by identifying and reducing statistical redundancy.

### SUMMARY OF THE INVENTION

The various embodiments of the present asymmetrically-powered neural image compression utilizing shallow decoders (may also be referred to as “asymmetrically-powered neural image compression”) contain several features, no single one of which is solely responsible for their desirable attributes. Without limiting the scope of the present embodiments, their more prominent features will now be discussed below. In particular, the present systems, methods, and devices for asymmetrically-powered neural image compression with shallow decoders will be discussed in the context of compression (e.g., encoding and decoding) of image data. However, the use of image data is merely exemplary and various other data may be used for asymmetrically-powered neural image compression with shallow decoders as appropriate to the requirements of a specific application in accordance with embodiments of the invention. After considering this discussion, and particularly after reading the section entitled “Detailed Description,” one will understand how the features of the present embodiments provide the advantages described here.

In a first aspect, a method for an asymmetrically-powered neural image compression with shallow decoders is provided, the method comprising: determining an asymmetric computation budget between an encoding process and a decoding process, wherein the asymmetric computation budget comprises an encoding computation budget that is greater than a decoding computation budget; performing the encoding process using an encoder, wherein the encoding process comprises generating encoded data from a source data using an analysis transform; and performing the decoding process using a shallow decoder, wherein the decoding process comprises generating decoded data from the encoded data using a synthesis transform.

In an embodiment of the first aspect, the encoding and decoding computation budgets are measured in computational complexity.

In another embodiment of the first aspect, the computational complexity is measured using thousand multiply-accumulate operations (“KMACs”) per pixel.

In another embodiment of the first aspect, the computational complexity is measured by a number of floating point operations (“FLOPs”).

In another embodiment of the first aspect, the encoding computation budget is at least forty-five times greater than the decoding computation budget.

In another embodiment of the first aspect, the encoding computation budget is at least thirty-five times greater than the decoding computation budget.

In another embodiment of the first aspect, the encoding computation budget is at least twenty-five times greater than the decoding computation budget.

In another embodiment of the first aspect, the encoding computation budget is at least ten times greater than the decoding computation budget.

In another embodiment of the first aspect, the encoding process is selected based on the encoding computation budget and a predetermined rate-distortion (“R-D”) performance.

In another embodiment of the first aspect, the decoding process is selected based on the decoding computation budget and the predetermined R-D performance.

In another embodiment of the first aspect, the encoding process comprises generating encoded data from the source data using an iterative optimization process.

In another embodiment of the first aspect, the analysis transform is a neural image compression analysis transform.

In another embodiment of the first aspect, the encoding process further comprises iterative encoding.

In another embodiment of the first aspect, the iterative encoding is Stochastic Gumbel Annealing (“SGA”).

In another embodiment of the first aspect, the synthesis transform is a two-layer nonlinear synthesis transform.

In another embodiment of the first aspect, the two-layer nonlinear synthesis transform comprises: a first transposed convolution layer having a convolution kernel size parameter (k₁), an upsampling stride parameter (s₁), and N output channels; an optional residential connection comprising a residual convolution transposed layer; and a second transposed convolution layer having a convolution kernel size parameter (k₂), an upsampling stride parameter (s₂), and a number of output channels specified by that of an image being reconstructed.

In another embodiment of the first aspect, the residual convolution transposed layer is implemented with same k₁, s₁, and N parameters as the first transposed convolution layer.

In another embodiment of the first aspect, a nonlinear activation is applied to an output of the first transposed convolution layer.

In another embodiment of the first aspect, the decoding computation budget remains low by selecting the k₁ to be greater than the k₂, and selecting the s₁ to be greater than the s₂.

In another embodiment of the first aspect, wherein k₁=13, s₁=8, k₂=5, s₂=2, N=12, and a residual connection is used and configured with the same parameters.

In another embodiment of the first aspect, the k₁=13, s₁=8, k₂=5, s₂=2, N=24, and no residual connection is used.

In another embodiment of the first aspect, the synthesis transform is a JPEG-like synthesis transform.

In another embodiment of the first aspect, the encoded data comprises a latent tensor of coefficients as in nonlinear transform coding, and the JPEG-like synthesis transform interprets the encoded data as coefficients of a linear synthesis transform and outputs decoded data in blocks.

In another embodiment of the first aspect, a (i,j)th block in the decoded data is computed as a linear combination of learned basis images functions weighted by a vector of encoded coefficients associated with a (i,j)th spatial location.

In another embodiment of the first aspect, the JPEG-like synthesis transform comprises overlapping basis functions with spatial extent k×k, where k≥s and k−s is a number of overlapping pixels, and basis functions are learned from data examples as in nonlinear transform coding.

In another embodiment of the first aspect, the JPEG-like synthesis further generates the decoded data using a sum of overlapping blocks.

In another embodiment of the first aspect, the output of the JPEG-like synthesis is computed by a transposed convolution operation with a kernel size parameter (k), and an upsampling stride parameter (s), and a number of output channels specified by that of the image being reconstructed.

In another embodiment of the first aspect, the image being reconstructed is an RBG image and the number of output channels equals 3.

### BRIEF DESCRIPTION OF THE DRAWINGS

The various embodiments of the present asymmetrically-powered neural image compression with shallow decoders will be discussed in detail with an emphasis on highlighting the advantageous features. These embodiments depict the novel and non-obvious features of asymmetrically-powered neural image compression shown in the accompanying drawings, which are for illustrative purposes only. These drawings include the following figures:

FIG. 1 is a diagram illustrating R-D performance on Kodak vs. decoding computation complexity as measured in KMACs (thousand multiply-accumulate operations) per pixel in accordance with an embodiment of the invention.

FIG. 2 is a diagram illustrating conceptual illustration of the image manifold parameterized by \hat{γ}(t) (bottom curve), obtained by decoding a straight path γ(t) (top curve) in the latent space in accordance with an embodiment of the invention.

FIG. 3 is a diagram illustrating visualizing the 1-D manifold of image reconstructions {\hat{γ}(t)|t∈[0,1]}(top row) and the linear interpolation between its two end points, {(1−t)\hat{x}⁽⁰⁾+t\hat{x}⁽¹⁾|t∈[0,1]}(bottom row) in accordance with an embodiment of the invention.

FIGS. 4A-B are diagrams illustrating the effect of traversing the synthesis manifold, with end points defined by random image pairs in accordance with an embodiment of the invention.

FIGS. 5A-B are diagrams illustrating comparison of the R-D performance of the proposed methods with existing neural image compression methods in accordance with an embodiment of the invention.

FIG. 6 is a diagram illustrating visualizing the different kinds of distortion artifacts at comparable low bit-rates between various methods. Left to right: Mean-Scale Hyperprior, two-layer synthesis (proposed), JPEG-like synthesis (proposed), and BPG in accordance with an embodiment of the invention.

FIG. 7 is a diagram illustrating Comparing the distortion artifacts at low bit-rate for different kernel sizes (k=16, 18, 32) in JPEG-like synthesis and a linear CNN (convolutional neural network) synthesis in accordance with an embodiment of the invention.

FIG. 8 is a diagram illustrating effect of increasing kernel size (k) on the performance of JPEG-like synthesis in accordance with an embodiment of the invention.

FIGS. 9A-D are diagrams illustrating ablation on various architectural choices of the proposed two-layer synthesis transform in accordance with an embodiment of the invention.

FIG. 10 is a diagram illustrating the proposed two-layer synthesis transform in accordance with an embodiment of the invention.

FIGS. 11A-C are diagrams illustrating the distance from the trajectory of decoded curve \hat{γ}(t) to the straight path between end-point reconstructions \hat{x}^{(t)}:=(1−t)\hat{x}⁽⁰⁾+t\hat{x}⁽¹⁾, and to the straight path between ground truth images x^{(t)}:(1−t)x⁽⁰⁾+tx⁽¹⁾ in accordance with an embodiment of the invention.

FIGS. 12A-C are diagrams illustrating curve-length ratio η vs. the straight-path-length for randomly chosen image pairs in different nonlinear transform coding architectures in accordance with an embodiment of the invention.

FIGS. 13A-D are diagrams illustrating visualization of learned filters in various neural compression methods with varying synthesis transform complexity in accordance with an embodiment of the invention.

FIGS. 14A-B are diagrams illustrating ablation results on the choice of analysis transform in the proposed two-layer synthesis architecture in accordance with an embodiment of the invention.

FIG. 15 is a diagram illustrating miscellaneous additional results in accordance with an embodiment of the invention.

FIG. 16 is a diagram illustrating aggregate LPIPS vs. BPP performance on Kodak in accordance with an embodiment of the invention.

FIG. 17 is a diagram illustrating aggregate PSNR vs. BPP performance on Tecnick in accordance with an embodiment of the invention.

FIG. 18 is a diagram illustrating aggregate MS-SSIM vs. BPP performance on Tecnick in accordance with an embodiment of the invention.

FIG. 19 is a diagram illustrating aggregate LPIPS vs. BPP performance on Tecnick in accordance with an embodiment of the invention.

FIG. 20 is a diagram illustrating aggregate PSNR vs. BPP performance on CLIC professional validation set in accordance with an embodiment of the invention.

FIG. 21 is a diagram illustrating aggregate MS-SSIM vs. BPP performance on CLIC professional validation set in accordance with an embodiment of the invention.

FIG. 22 is a diagram illustrating aggregate LPIPS vs. BPP performance on CLIC professional validation set in accordance with an embodiment of the invention.

FIG. 23 is a system diagram illustrating an example asymmetrically-powered neural compression with shallow decoders in accordance with an embodiment of the invention.

FIG. 24 is a diagram illustrating an example server in accordance with an embodiment of the invention.

FIG. 25 is a diagram illustrating a client device in accordance with an embodiment of the invention.

FIG. 26 is a flow chart illustration a process for asymmetrically-powered neural image compression using shallow decoders in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

One aspect of the present embodiments includes the realization that neural image compression methods have seen increasingly strong performance in recent years. However, neural image compression suffers orders of magnitude higher computational complexity compared to traditional codecs, which hinders their real-world deployment. The present asymmetrically-powered neural image compression with shallow decoders provide systems, methods, and devices for closing this gap in decoding complexity by utilizing shallow and/or linear decoding transforms. In many embodiments, such transforms may resemble that of Joint Photographic Experts Group (“JPEG”) compression, as further described below. To compensate for the resulting drop in compression performance, the present embodiments exploit the often asymmetrical computation budget between encoding and decoding, by adopting more powerful encoder networks and iterative encoding. The present embodiments also provide a theoretical formalization of the intuition behind, and experimental results to establish a new frontier in the trade-off between rate-distortion and decoding complexity for neural image compression. As further described below, the present embodiments achieve rate-distortion performance competitive with the established Mean-scale Hyperprior architecture at less than 50K decoding FLOPs/pixel, reducing the baseline's overall decoding complexity by 80%, or over 90% for the synthesis transform alone.

Turning now to the drawings, asymmetrically-powered neural image compression with shallow decoders in accordance with embodiments of the invention are provided. As described above, neural image compression (e.g., deep-learning-based methods) for data compression have achieved increasingly strong performance on visual data compression, increasingly exceeding classical codecs in rate-distortion performance. However, their enormous computational complexity compared to classical codecs, especially required for decoding, is a road-block towards their wider adoption. Inspired by the parallel between nonlinear transform coding and traditional transform coding, the present embodiments provide systems, methods, and devices that replace deep convolutional decoders with extremely lightweight and shallow (and even linear) decoding transforms. As provided below, asymmetrically-powered neural image compression with shallow decoders establishes R-D (rate-distortion) performances of conventional neural image compression while operating at a lower limit of decoding complexity.

Asymmetrically-powered neural image compression provides insights into the image manifold parameterized by learned synthesis transforms in nonlinear transform coding. Prior findings suggest that the learned manifold is relatively flat and preserves linear combinations in the latent space, in contrast to its typically highly nonlinear counterpart in generative modeling. Further, the present embodiments include insights into the effect of linear synthesis transform within a typical nonlinear transform coding architecture equipped with a hyperprior. The present embodiments show that, perhaps surprisingly, a JPEG-like synthesis may perform similarly to a deep linear convolutional neural network (CNN), and the present embodiments shed light on the role of nonlinearity in the perceptual quality of neural image compression with nonlinear transform coding. Furthermore, the present embodiments provide a theoretical analysis of the R-D cost of neural lossy compression in an asymptotic setting, which quantifies the performance implications of varying the complexity of encoding and decoding procedures. In several embodiments, asymmetrically-powered neural image compression may include pairing the synthesis transform (e.g., JPEG-like synthesis) with powerful encoding methods, and/or augmenting it with a single hidden layer. This approach may yield a new state-of-the-art result in the trade-off between R-D performance and decoding complexity for nonlinear transform coding. For example, in various embodiments, asymmetrically-powered neural image compression may yield results in the regime of sub-50K FLOPs per pixel believed to be dominated by classical codecs. Considerations for asymmetrically-powered neural image compression in accordance with embodiments of the invention are further described below.

### Considerations for Asymmetrically-Powered Neural Image Compression

### Neural Image Compression

Most existing neural lossy compression approaches are based on the paradigm of nonlinear transform coding (“NTC”). Traditional transform coding involves designing a pair of analysis (encoding) transform f and synthesis (decoding) transform g such that the encoded representation of the data achieves good R-D (rate-distortion) performance. NTC essentially learns this process through data-driven optimization. Let the input color image be x∈R^{H×w×3}. The analysis transform computes a continuous latent representation z:=f(x), which may then be quantized to \hat{z}=└z┐ and transmitted to a receiver (e.g., a client device) under an entropy model P(\hat{z}); the final reconstruction may then be computed by the synthesis transform as \hat{x}=g(\hat{z}). The hard quantization is typically replaced by uniform noise to enable end-to-end training.

Instead of orthogonal linear transforms in traditional transform coding, the analysis and synthesis transforms in NTC are typically convolutional neural networks (“CNNs”) or variants with residual connections or attention mechanisms. Typically, the (convolutional) latent coefficients z∈R^{h,w,C} form a 3D tensor with C channels and a spatial extent (h,w) smaller than the input image. We denote the downsampling factor by s, i.e., s=H/h=W/w; this is also the “upsampling” factor of the synthesis transform.

To improve the bitrate of NTC, a hyperprior may be used to parameterize the entropy model P(\hat{z}) via another set of latent coefficients h and an associated pair of transforms (fₕ, gₕ). The hyper analysis fₕ, computes h=fₕ(\hat{z}) at encoding time, and the hyper synthesis gₕ predicts the (conditional) entropy model P(\hat{z}|ĥ) based on the quantized ĥ=└h┐. For illustrative purposes, the present embodiments are described in the context of a Mean-scale Hyperprior from Minnen et al. as a base architecture, which is widely used as a basis for other NTC methods. In this architecture, the various transforms are parameterized by CNNs, with GDN (generalized divisive normalization) activation being used in the analysis and synthesis transforms and ReLU activation in the hyper transforms. Importantly, the synthesis transform (g) accounts for over 80% of the overall decoding complexity (see Table 1 below), and the present embodiments focus on such considerations, as further described below. Although a specific base architecture is selected, the use of a particular base architecture is for illustrative purposes, and various other base architectures as appropriate to the requirements of a specific application can be utilized in accordance with embodiments of the invention.

### Iterative Inference

Given an image x to be encoded, instead of computing its discrete representation by rounding the output of the analysis transform, i.e., \hat{z}=└f(x)┐, it has been suggested to cast the encoding problem as that of variational inference, and to infer the discrete representation that optimizes the per-data R-D cost. A proposed method, Stochastic Gumbel Annealing (“SGA”), essentially solves a discrete optimization problem by constructing a categorical variational distribution q(z|x) and optimizing w.r.t. its parameters by gradient descent, while annealing it to become deterministic so as to close the quantization gap. In some embodiments, we may adopt the proposed standalone procedure and may run SGA at test time, essentially treating it as a powerful black-box encoding procedure for a given NTC architecture. Methodologies for asymmetrically-powered neural image compression in accordance with embodiments of the invention are further described below.

### Methodology

The present embodiments include providing new empirical insights into the qualitative similarities between synthesis transforms in NTC and traditional transform coding, as further described below. In many embodiments, such insights may provide motivations to adopt simpler synthesis transforms, such as JPEG-like block-wise linear transforms, which are computationally much more efficient than deep neural networks, as further described below. The present embodiments also include analyzing resulting effects on R-D performance and mitigating the performance drop using powerful encoding methods, as further described below.

### The Case for Shallow Decoders

Although the transforms in NTC are generally black-box deep CNNs, it has been shown that they in fact bear strong qualitative resemblance to the orthogonal transforms in traditional transform coding. It has been shown that the learned synthesis transforms in various NTC architectures satisfy a certain separability property, i.e., a latent tensor can be decomposed spatially or across channels, then decoded separately, and finally combined in the pixel space to produce a reasonable reconstruction. Moreover, decoding “standard basis” tensors in the latent space produces image patterns resembling the basis functions of orthogonal transforms.

Here, we obtain new insights into the behavior of the learned synthesis transform in NTC. The present embodiments show that the manifold of image reconstructions is approximately flat, in the sense that straight paths in the latent space may be mapped to approximately straight paths (i.e., naive linear interpolations) in the pixel space. Additionally, the learned synthesis transform exhibits an approximate “mixup” behavior despite the lack of such explicit regularization during training.

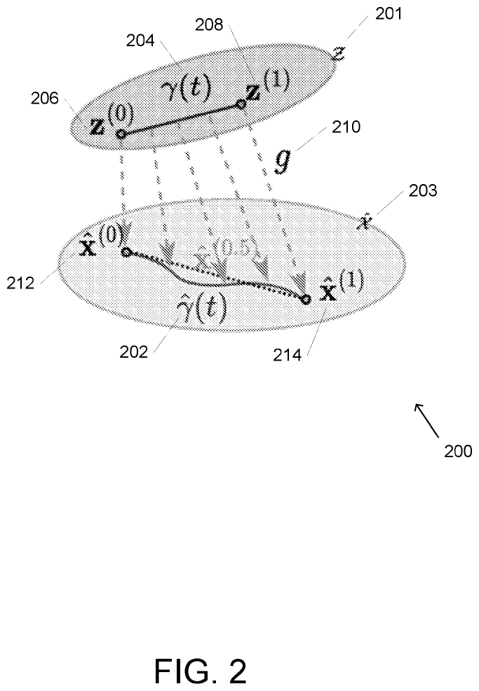

A diagram 200 illustrating conceptual illustration of the image manifold parameterized by \hat{γ}(t) 202, obtained by decoding a straight path γ(t) 204 in the latent space in accordance with an embodiment of the invention is shown in FIG. 2. Suppose we are given an arbitrary pair of images (x⁽⁰⁾, x⁽¹⁾), and we obtain their latent coefficients (z⁽⁰⁾, z⁽¹⁾) 206, 208, respectively, using the analysis transform. Let γ: [0,1]→Z be the straight path in the latent space 201 defined by the two latent tensors, i.e., γ(t):=(1−t)z⁽⁰⁾+tz⁽¹⁾. Using the synthesis transform g 210, we can then map the curve γ(t) 204 in the latent space 201 to curve \hat{γ}(t) 202 in the space of reconstructed images (i.e., image space 203), defined by \hat{γ}(t):=g(γ(t)). We denote the two end-points 212, 214 of the curve by \hat{x}⁽⁰⁾:=g(z⁽⁰⁾)=\hat{γ}(0) 212 and \hat{x}⁽¹⁾:=g(z⁽¹⁾)=\vec{γ}(1), respectively. Instead of traversing the image manifold parameterized by g 210, we could also travel between the two end-points in a straight path, which we define by \hat{x}^{(t)}:=(1−t)\hat{x}⁽⁰⁾+t\hat{x}⁽¹⁾ and is given by a simple linear interpolation in the pixel space (may also be referred to as the “image space”).

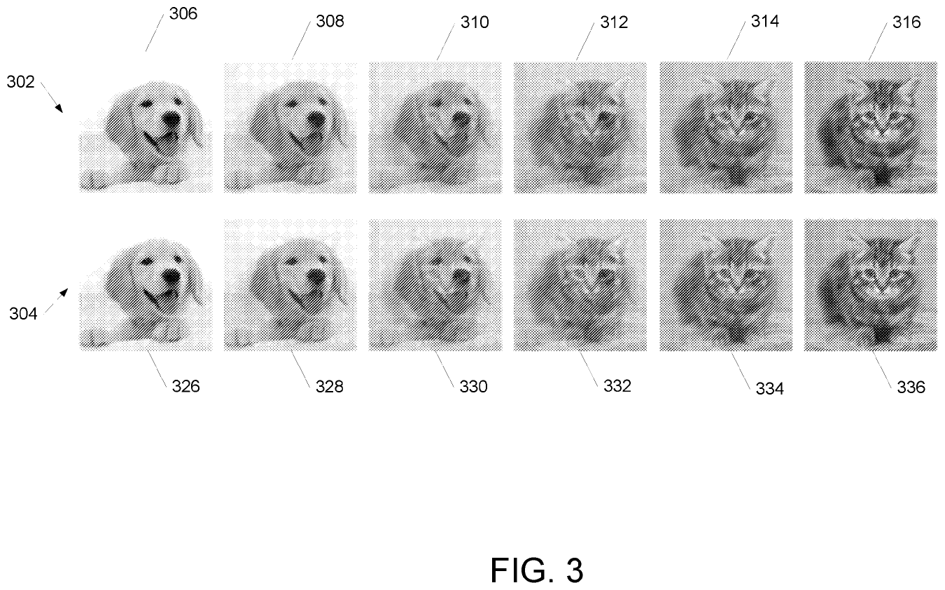

A diagram illustrating visualizing the 1-D manifold of image reconstructions {\hat{γ}(t)|t∈[0,1]}(top row 302) and the linear interpolation between its two end points, {(1−t)\hat{x}⁽⁰⁾+t\hat{x}⁽¹⁾|t∈[0,1]}(bottom row 304) in accordance with an embodiment of the invention is shown in FIG. 3. Diagram 300 visualizes an example of the resulting curve of images \hat{γ}(t) (top row 302), compared to the interpolating straight path \hat{x}^{(t)} (bottom row 304), as t goes from 0 to 1. The results appear very similar, suggesting the latent coefficients largely carry local and mostly low-level information about the image signal. For example, the visualization of a resulting curve of image \hat{γ}(t) 306 appears very similar to the interpolating straight path image \hat{x}^{(t)} 316, resulting curve of image \hat{γ}(t) 308 appears very similar to the interpolating straight path image \hat{x}^{(t)} 328, resulting curve of image \hat{γ}(t) 310 appears very similar to the interpolating straight path image \hat{x}^{(t)} 330, resulting curve of image \hat{γ}(t) 312 appears very similar to the interpolating straight path image \hat{x}^{(t)} 332, and resulting curve of image \hat{γ}(t) 314 appears very similar to the interpolating straight path image \hat{x}^{(t)} 336.

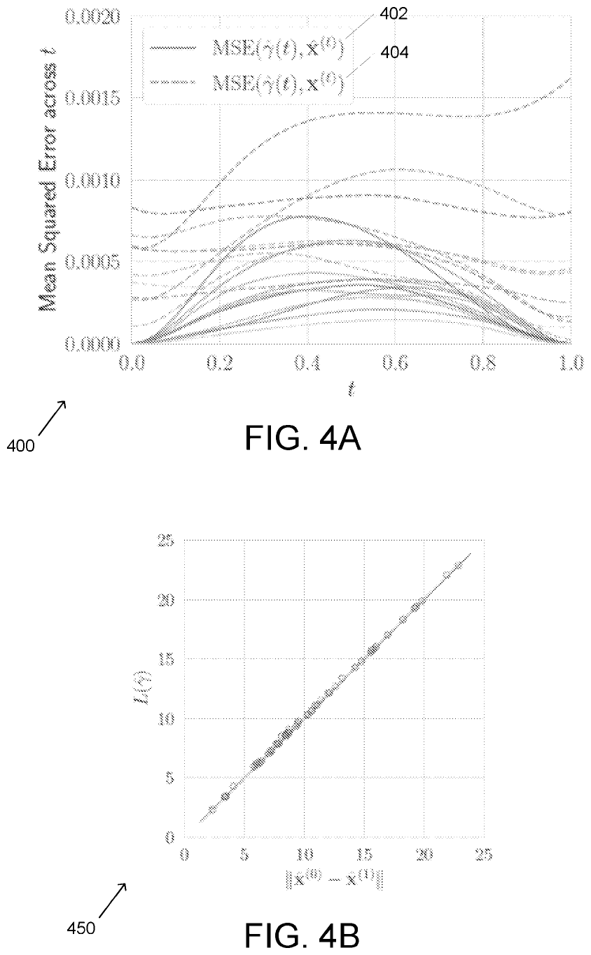

FIGS. 4A-B are diagrams illustrating the effect of traversing the synthesis manifold, with end points defined by random image pairs. FIG. 4A provides a diagram 400 that illustrates mean-squared error (“MSE”) distance between the decoded curve \hat{γ}(t) and two kinds of straight paths in the image space, computed on random pairs of images. Solid curves 402 compare the decoded curves \hat{γ}(t) to the corresponding interpolation \hat{x}^{(t)} of reconstruction pairs, and dashed curves 404 compare the decoded curves \hat{γ}(t) to the corresponding interpolation x^{(t)} of original image pairs. In both cases, the curves 402, 404, appear to vary smoothly with t, and curve 404 appears roughly linear for certain image inputs.

Naively, the fact that the solid lines 402 are not identically zero may suggest that the two curves \hat{γ}(t) and \hat{x}^{(t)} do not align perfectly, as they would for a linear (affine) g. However, since the parameterization of any curve is not unique, we get a better sense of the behavior of the manifold curve \hat{γ}(t) by considering its length L(\hat{γ}) in relation to the length of the interpolating straight path ∥\hat{x}⁽⁰⁾−\hat{x}⁽¹⁾∥. FIG. 4B provides a diagram 450 that illustrates the length of the curve \hat{γ}(t) vs. that of the interpolating straight path \hat{x}(t) in accordance with an embodiment of the invention. The image pixel values are scaled to [−0.5, 0.5]. We compute the two lengths (the curve length can be computed using the Jacobian of g, as further described below), and plot them for random image pairs in FIG. 4B. The resulting curve lengths fall very closely to the straight path lengths regardless of the absolute length of the curves, indicating that the curves globally follow nearly straight paths. Note that if g was linear (affine), then \hat{γ}(t) and z(t) would perfectly overlap.

Additionally, inspired by mixup regularization, we examine how well the synthesized curve \hat{γ}(t) can reconstruct the linear interpolation of the two ground truth images, defined by x(t):=(1−t)x⁽⁰⁾+tx⁽¹⁾. FIG. 4A plots the reconstruction error for the same random image pairs in dashed lines 404, and shows that the synthesized curve \hat{γ}(t) generally offers consistent reconstruction quality along the entire trajectory. Note that if g was linear (affine), then this reconstruction error would vary linearly across t, and the dashed lines 404 would appear straight.

The above observations form a stark contrast to the typical behavior of the decoder network in generative modeling, where different images tend to be separated by regions of low density under the model, and the decoder function varies rapidly when crossing such boundaries, e.g., across a linear interpolation of images in pixel space.

We obtained these results with a Mean-scale Hyperprior model trained with λ=0.01, and we observe similar behavior at other bit-rates (with the curves \hat{γ} becoming even “straighter” at higher bit-rates) and in various NTC architectures, as further described below. Empirical observations corroborate the earlier findings, and raise the question: Given the many similarities, can we replace the deep convolutional synthesis in NTC with a linear (affine) function? Our motivation is mainly computational: a linear synthesis can offer drastic computation savings over deep neural networks. This is not necessarily the case for an arbitrary linear (affine) function from the latent to image space, so some embodiments may be restricted to efficient convolutional architectures. As we show empirically below, a single JPEG-like transform with a large enough kernel size can emulate a more general cascade of transposed convolutions, while being much more computationally efficient. Compared to fixed and orthogonal transforms in traditional transform coding, learning a linear synthesis from data allows the present embodiments to still benefit from end-to-end optimization. As further described below, the present embodiments show that strategically incorporating a small amount of nonlinearity can significantly improve the R-D performance without much increase in computation complexity.

### Shallow Decoders for Asymmetrically-Powered Neural Image Compression

JPEG-like synthesis—At its core, JPEG works by dividing an input image into 8×8 blocks and applying block-wise linear transform coding. This can be implemented efficiently in hardware and is a key factor in JPEG's enduring popularity. By analogy to JPEG, the present embodiments may interpret the h×w×C latent tensor in NTC as the coefficients of a linear synthesis transform. In the most basic form, the output reconstructions may be computed in s×s blocks, similarly to JPEG. For example, the (i,j)th block reconstruction may be computed as a linear combination of (learned) “basis images” K_{c} ∈R^{S×S×c}^{ₒᵤₜ}, c=1, . . . , C, weighted by the vector of (quantized) coefficients z_{i,j} ∈R^{C} associated with the (i,j)th spatial location:

$${\hat{B}}_{i , j} = {\sum }_{c = 1}^{C} {z}_{i , j , c} {K}_{c} . \qquad ( 1 )$$

Note that, in some embodiments, we recover the per-channel discrete cosine transform of JPEG by setting s=8, C=64, Cₒᵤₜ=1, and {K_{c}, c=1, . . . , 64} to be the bases of the 8×8 discrete cosine transform. Eq. 1 can be implemented efficiently via a transposed convolution on z using K as the kernel weights and s as the stride. In terms of MACs, the computation complexity of the JPEG-like synthesis then equals

$$M ( JPEG - like ) = C \times h \times w \times {s}^{2} \times {C}_{out} , \qquad ( 2 )$$

where Cₒᵤₜ=3 for a color image. Note that for a given latent tensor and “upsampling” rate s, Eq. 2 gives the minimum achievable MACs by any non-degenerate synthesis transform based on (transposed) convolutions. As further described below, although the minimal JPEG-like synthesis drastically reduces the decoding complexity, it can introduce severe blocking artifacts since the blocks are reconstructed independently. We therefore allow overlapping basis functions with spatial extent k×k, where k≥s and k−s is the number of overlapping pixels; we compute each k×k blocks as in Eq. 1, then form the reconstructed image by taking the sum of the (overlapping) blocks. This corresponds to simply increasing the kernel size from (s,s) to (k,k) in the corresponding transposed convolution, and increases the s² factor in Eq. 2 to k².

Two-layer nonlinear synthesis—Despite its computational efficiency, in some embodiments, the JPEG-like synthesis can be overly restrictive. Indeed, nonlinear transform coding benefits from the ability of the synthesis transform to adapt to the shape of the data manifold. We therefore may introduce a small degree of nonlinearity in the JPEG-like transform. Many possibilities exist, and we found that introducing a single hidden layer with nonlinearity to work well. In many embodiments, we use two layers of transposed convolutions (conv_1, conv_2), with strides (s₁, s₂), kernel sizes (k₁, k₂), and output channels (N, Cₒᵤₜ) respectively. At lower bit-rates, we found it more parameter- and compute-efficient to also allow a residual connection from z to the hidden activation using another transposed convolution conv_res (see more details below). Thus, given a latent tensor z∈R^{h,w,c} the output is g(z)=conv_2(ξ(conv_1(z))+conv_res(z)), where ξ is a nonlinear activation.

The MAC count in this architecture is then approximately

$$M ( 2 - layer ) = C \times h \times w \times {k}_{1}^{2} \times 2 N + N \times {hs}_{1} \times {ws}_{1} \times {k}_{2}^{2} \times {C}_{out} . \qquad ( 3 )$$

To keep this decoding complexity low, we may use large convolution kernels (k₁=13) with aggressive upsampling (s₁=8) in the first layer, in the spirit of a JPEG-like synthesis, followed by a lightweight output layer with a smaller upsampling factor (s₂=2) and kernel size (k₂=5). We use the simplified (inverse) GDN activation for ξ as it gave the best R-D performance with minor computational overhead. Architectural choices and considerations are further described below.

### Formalizing the Role of the Encoder in Lossy Compression Performance

Here, we analyze the rate-distortion performance of neural lossy compression in an idealized, asymptotic setting. Our novel decomposition of the R-D objective pinpoints the performance loss caused by restricting to a simpler (e.g., linear) decoding transform, and suggests reducing the inference gap as a simple and theoretically principled remedy.

Consider a general neural lossy compressor operating as follows. Let Z be a latent space, p(z) a prior distribution over known to both the sender and receiver, and g:Z→\hat{X} the synthesis transform belonging to a family of functions G. Given a data point x, the sender computes an inference distribution q(z|x); this can be the output of an encoder network, or a more sophisticated procedure such as iterative optimization with SGA. We assume relative entropy coding is applied with minimal overhead, so that the sender can send a sample of z~q(z|x) with an average bit-rate not much higher than KLq(z|x)∥q(z)). Given a neural compression method, which can be identified with the tuple (q(x), g, p(z)), its R-D cost on data distributed according to P_{X} thus has the form of a negative ELBO

$$ℒ ( q ( z \vert x ) , g , p ( z ) ) := {λ𝔼}_{x ∼ {P}_{X} , z ∼ q ( z \vert x )} [ ρ ( x , g ( z ) ) ] + {𝔼}_{x ∼ {P}_{X}} [ K L ( q ( z \vert x ) \vert \vert p ( z ) ) ] , \qquad ( 4 )$$

where λ≥0 controls the R-D tradeoff, and ρ:X×\hat{X}→[0, ∞) is the distortion function (commonly the MSE). Note that the encoding distribution q(z|x) appears in both the rate and distortion terms above. We show that the compression cost admits the following alternative decomposition, where the effects of p(z), g, and q(z|x) can be isolated:

$$ℒ ( q ( z \vert x ) , g , p ( z ) ) := = {\underbrace{ℱ ( 𝒢 )}}_{irreducible} + {\underbrace{( {𝔼}_{x ∼ {P}_{X}} [ - log {Γ}_{g , p ( z )} ( x ) ] - ℱ ( 𝒢 ) )}}_{modeling gap} \qquad ( 5 )$$

$$+ {\underbrace{{𝔼}_{x ∼ {P}_{X}} [ K L ( q ( z \vert x ) \vert \vert p ( z \vert x ) ]}}_{inference gap} . \qquad ( 6 )$$

The derivation and definition of various quantities are further described below, and mirror a similar decomposition in lossless compression; here we give a high-level explanation of the three terms. The first term represents the fundamentally irreducible cost of compression; this depends only on the intrinsic compressibility of the data P_{X} and the transform family G. The second term represents the excess cost of compression given our particular choice of decoding architecture, i.e., the prior p(z) and transform g, compared to the optimum achievable (the first term); we thus call it the modeling gap. Note that for each choice of (g,p(z)), the optimal inference distribution has an explicit formula, which allows us to write the R-D cost under optimal inference in the form of a negative log partition function (the −log Γ term). Finally, we consider the effect of suboptimal inference and isolate it in the third term, representing the overhead caused by a sub-optimal encoding/inference method q(z|x) for a given model (g, p(z)); we call it the inference gap.

Although the above result is derived in an asymptotic setting, it still gives us insight about the performance of neural lossy compression at varying decoder complexity. When we use a simpler synthesis transform architecture, we place restrictions on our transform family G, thus causing the first (irreducible) part of compression cost to increase. The modeling gap may or may not increase as a result, but we can typically lower the overall compression cost by reducing the inference gap, without affecting the decoding computational complexity.

The present embodiments explore two orthogonal approaches for reducing the inference gap, which can be further decomposed into an (1) approximation gap and (2) amortization gap. Correspondingly, for a given decoding architecture, the present embodiments propose to reduce (1) by using a more powerful analysis transform, e.g., the ones from a recent SOTA method such as ELIC, and reduce (2) by performing iterative encoding using SGA at compression time.

Although specific methodologies for asymmetrically-powered neural image compression are discussed above with respect to FIGS. 2-4B, any of a variety of methodologies for asymmetrically-powered neural image compression utilizing various encoders and linear and/or shallow decoders as appropriate to the requirements of a specific application can be utilized in accordance with embodiments of the invention. Experiments using asymmetrically-powered neural image compression with shallow decoders in accordance with embodiments of the invention are further described below.

### EXPERIMENTS

### Data and Training

Models may be trained utilizing various data sets. For example, the various models described herein were trained on random 256×256 image crops from the COCO 2017 dataset. Further, various training procedures may be utilized. For example, we utilized standard training procedures based on additive uniform noise and optimized for MSE as the distortion metric, but it is also possible to train with “mixed quantization” or other quantization strategy, or target a different distortion metric than the MSE.

Comparison with Existing Methods

We compare the present embodiments with standard neural compression methods and state-of-the-art methods targeting computational efficiency. We obtain the baseline results from the CompressAI library, or trace the results from papers when they are not available. For our shallow synthesis transforms, we use k=18 in the JPEG-like synthesis, and N=12, k₁=13, k₂=5 with a residual connection in the 2-layer synthesis; we ablate on these choices as further described below.

Table 1 (reproduced below) summarizes the computational complexity of various methods, ordered by decreasing overall decoding complexity. We use the keras-flops package to measure the FLOPs on 512×768 images, and report the results in KMACs (thousand multiply-accumulates) per pixel. Note that the Factorized Prior architecture lacks the hyperprior, while CHARM and ELIC use autoregressive computation in the hyperprior. Our proposed models borrow the same hyperprior from Mean-Scale Hyperprior.

TABLE 1
Computational complexity of various neural compression methods, v.s. average BD rate savings relative to
BPG [8] on Kodak. Complexity is measured in KMACs (thousand multiply-accumulate operations) per pixel, and does
not include entropy coding. f, fₕ, g, gₕ stand for analysis, hyper analysis, synthesis, and hyper synthesis transforms.
We also report the parameter count of synthesis transforms (g) in the second-to-last column, and a rough estimate
of the overall encoding complexity of SGA-based encoding (~10⁵ KMACs/pixel).

| | Computational complexity (KMAC) | | | | | | Syn. param | BD rate |
|---|---|---|---|---|---|---|---|---|
| Method | f | fₕ | enc. tot. | g | gₕ | dec. tot. | count (Mil.) | savings (%) ↑ |
| He 2022 ELIC [25] | 255.42 | 6.73 | 262.15 | 255.42 | 126.57 | 381.99 | 7.34 | 26.98 |
| Minnen 2020 CHARM [37] | 93.79 | 5.90 | 99.70 | 93.79 | 256.51 | 350.30 | 4.18 | 20.02 |
| Wang 2023 EVC [48] | 263.25 | 1.86 | 265.11 | 257.94 | 34.82 | 292.76 | 3.38 | 22.56 |
| Minnen 2018 Hyperprior [36] | 93.79 | 6.73 | 100.52 | 93.79 | 15.18 | 108.97 | 3.43 | 3.30 |
| Ballé 2017 Factorized Prior [4] | 81.63 | 0.00 | 81.63 | 81.63 | 0.00 | 81.63 | 3.39 | −32.93 |
| 2-layer syn. + SGA (proposed) | 255.42 | 6.73 | ~10⁵ | 5.34 | 15.18 | 20.52 | 1.30 | 4.67 |
| 2-layer syn. (proposed) | 255.42 | 6.73 | 262.15 | 5.34 | 15.18 | 20.52 | 1.30 | −5.19 |
| JPEG-like syn. (proposed) | 255.42 | 6.73 | 262.15 | 1.22 | 15.18 | 16.39 | 0.31 | −20.95 |

While most existing methods use analysis and synthesis transforms with symmetric computational complexity, our proposed methods adopt the relatively more expensive analysis transform from ELIC (column “f”), and drastically reduces the complexity of the synthesis transform (column “g”)—over 50 times smaller than in ELIC, and 17 smaller than in Mean-Scale Hyperprior. As a result, the hyper synthesis transform (the same as in Mean-Scale Hyperprior) accounts for a great majority of our overall decoding complexity.

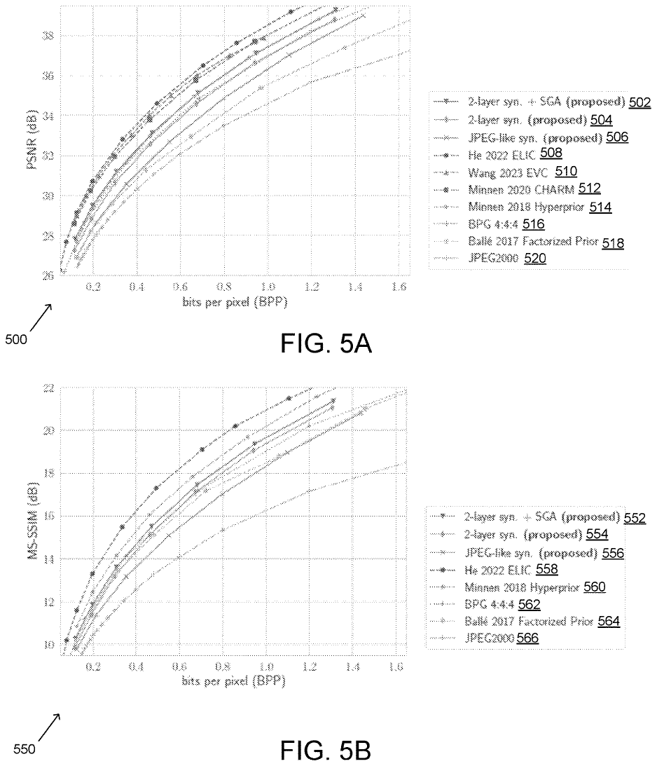

FIGS. 5A-B are diagrams illustrating comparison of the R-D performance of the proposed methods with existing neural image compression methods. In reference to FIG. 5A, the diagram 500 illustrates R-D performance on Kodak where the quality is measured in PSNR (dB) (the higher the better). Specifically, we plot the R-D performance of various methods on the Kodak benchmark, with quality measured in PSNR. For example, the various methods include the (1) proposed 2-layer synthesis+SGA 502, (2) proposed 2-layer synthesis 504, (3) JPEG-like synthesis 506, (4) He 2022 ELIC 508, (5) Wang 2023 EVC 510, (6) Minnen 2020 CHARM 512, (7) Minnen 2018 Hyperprior 514, (8) BPG 4:4:4 516, (9) Ballè 2017 Factorized Prior 518, and (10) JPEG2000 520.

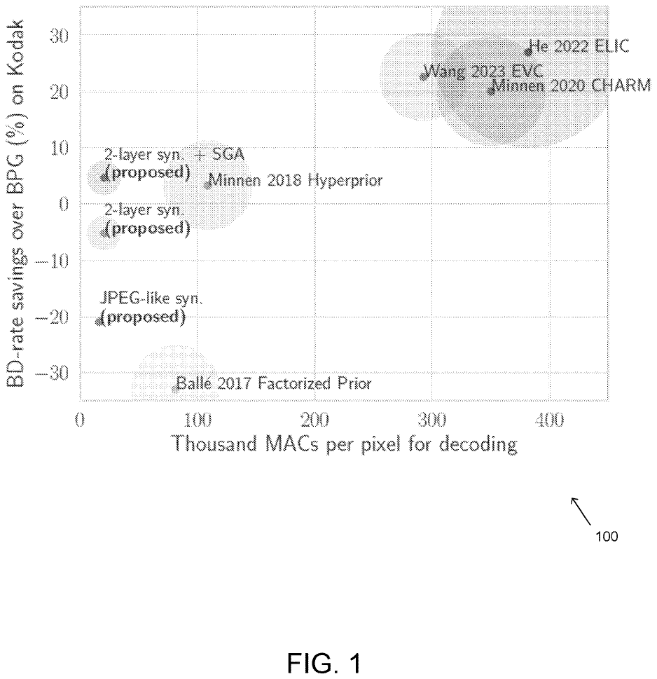

We also compute the BD rate savings (%) relative to BPG, and summarize the average BD rate savings vs. the total decoding complexity in Table 1 and FIG. 1. A diagram 100 illustrating R-D performance on Kodak vs. decoding computation complexity as measured in KMACs (thousand multiply-accumulate operations) per pixel in accordance with an embodiment of the invention is shown in FIG. 1.

In reference to FIG. 5A, our model with ELIC analysis transform and JPEG-like synthesis transform 506 comfortably outperforms the Factorized Prior 518 architecture; the latter 518 employs a more expensive CNN synthesis transform but a less powerful entropy model. However, our JPEG-like synthesis 506 still significantly lags behind BPG 516 and the Mean-Scale Hyperprior 514. By adopting the two-layer synthesis 504, the overall decoding complexity increases marginally (since the majority of complexity comes from the hyper decoder), while the R-D performance improves significantly, to within ≤6% bit-rate of BPG. Finally, performing iterative encoding with SGA 502 gives a further boost in R-D performance, outperforming the Mean-Scale Hyperprior 514 (and BPG 516) without incurring any additional decoding complexity.

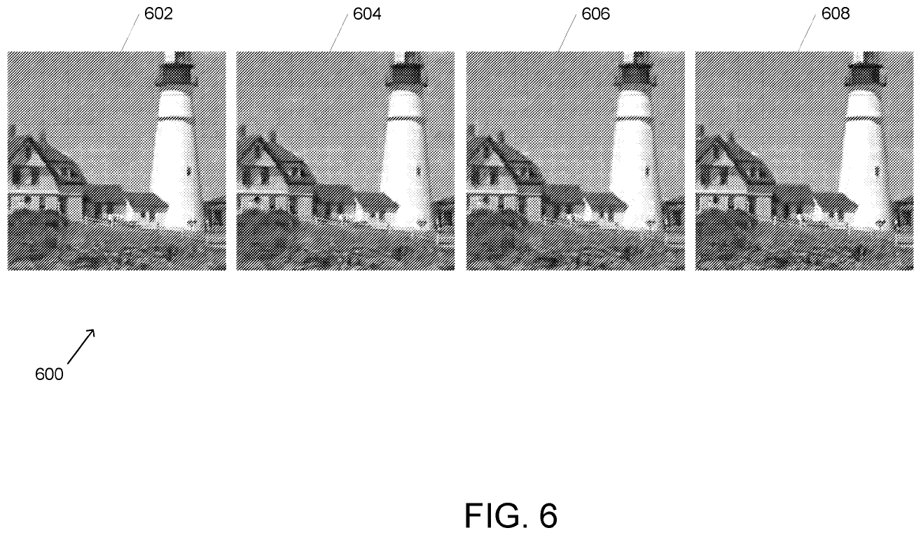

Additionally, we examine the R-D performance using the more perceptually relevant MS-SSIM metric. In reference to FIG. 5B, R-D performance of various methods on Kodak with quality measured in MS-SSIM dB (the higher the better) in accordance with an embodiment of the invention is shown in FIG. 5B. For example, the various methods include the (1) proposed 2-layer synthesis+SGA 552, (2) proposed 2-layer synthesis 554, (3) JPEG-like synthesis 556, (4) He 2022 ELIC 558, (5) Minnen 2018 Hyperprior 560, (6) BPG 4:4:4 562, (7) Ballè 2017 Factorized Prior 564, and (8) JPEG2000 566. Following standard practice, we display it in dB as −10(1−MS-SSIM). We observe largely the same phenomenon as before under PSNR, except that the existing methods based on CNN decoders achieve relatively much stronger performance compared to traditional codecs such as BPG 562 and JPEG 2000 566. Our proposed method with a two-layer synthesis and iterative encoding 552 still outperforms BPG 562, but no longer outperforms the Mean-Scale Hyperprior 560. Indeed, as we see in FIG. 6, the reconstructions of the proposed shallow synthesis transforms (604, 606) can exhibit artifacts similar to classical codecs (e.g., BPG, 608) at low bit-rates, such as blocking or ringing, but to a lesser degree with the nonlinear two-layer synthesis (second panel, 604) than the JPEG-like synthesis (third panel, 606). A diagram illustrating visualizing the different kinds of distortion artifacts at comparable low bit-rates between various methods in accordance with an embodiment of the invention is shown in FIG. 6. The diagram 600 include visualization for various methods include Mean-Scale Hyperprior 602, two-layer synthesis (proposed) 604, JPEG-like synthesis (proposed) 606, and BPG 608.

As further described below, we report additional R-D results evaluated on Tecnick and the CLIC validation set, as well as under the perceptual distortion LPIPS. Overall, in some embodiments, the two-layer synthesis with SGA encoding matches the Hyperprior performance when evaluated on PSNR. In some embodiments, it may under-perform by 8% ~12% (in BD-rate) when evaluated on either MS-SSIM or LPIPS.

### JPEG-Like Synthesis

In this section, we study the JPEG-like synthesis in isolation. We start with the Mean-Scale Hyperprior architecture, and replace its CNN synthesis with a single transposed convolution with varying kernel sizes. Additionally, instead of replacing the CNN synthesis entirely, we also consider a linear version of it (“linear CNN synthesis”) where we remove all the nonlinear activation functions. This results in a composition of four transposed convolution layers, which in general cannot be expressed by a single transposed convolution; however, note that this is still a linear (affine) map from the latent space to image space.

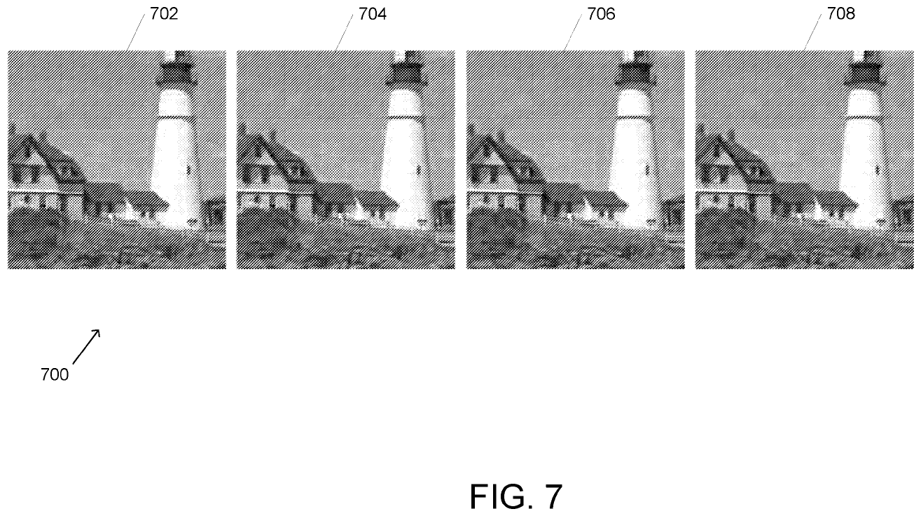

A diagram 700 illustrates comparing the distortion artifacts at low bit-rate for different kernel sizes (k=16, 18, 32) in JPEG-like synthesis, as well as a linear CNN synthesis in accordance with an embodiment of the invention. JPEG-like synthesis k=16 is provided in panel 702, JPEG-like synthesis k−18 is provided in panel 704, JPEG-like synthesis k−32 is provided in panel 706, and linear CNN synthesis is provided in panel 708. Specifically, FIG. 7 illustrates the distortion artifacts of the JPEG-like synthesis and linear CNN synthesis at comparable bit-rates. The results provide that using the smallest non-degenerate kernel size (k=s=16) results in severe blocking artifacts, as seen in the 16×16 cloud patches in the sky in panel 702, similarly to JPEG. In addition, the results provide that increasing k by a small amount (16→18) already helps smooth out the blocking, but further increase gives diminishing returns. Furthermore, at k=32, the reconstruction of JPEG-like synthesis no longer shows obvious blocking artifacts, but shows ringing artifacts near object boundaries instead; the reconstruction by the linear CNN synthesis gives visually very similar results.

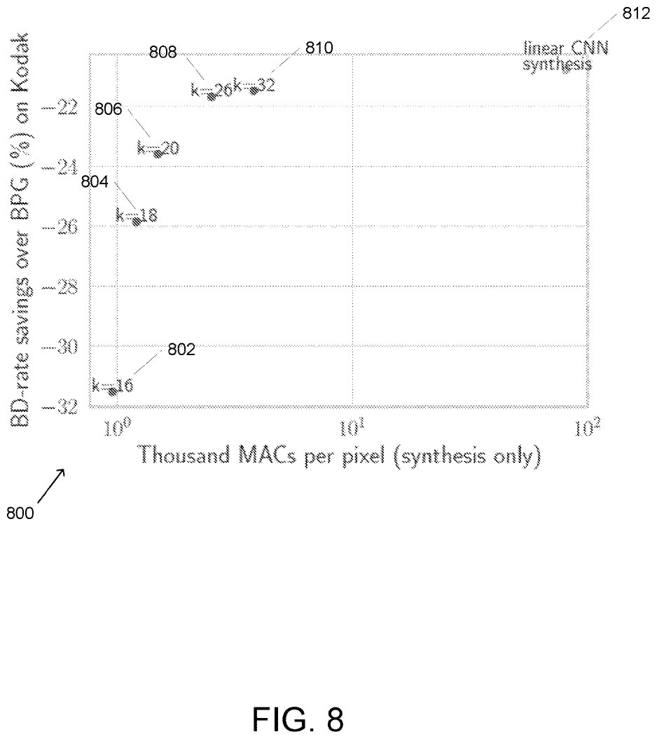

A diagram 800 illustrating effect of increasing kernel size (k) on the performance of JPEG-like synthesis in accordance with an embodiment of the invention is shown in FIG. 8. Diagram 800 includes results for JPEG-like synthesis with k=16 802, k=18 804, k=20 806, k=26 808, and k=32 810, and linear CNN synthesis 812. Indeed, diagram 800 confirms that increasing k quantitatively improves the R-D performance of the JPEG-like synthesis, with k=26 808 approaching the R-D performance of the linear CNN synthesis 812 (within 1% aggregate bit-rate) while requiring 94% less FLOPs. We conclude that for image compression, a single transposed convolution with large enough kernel size can largely emulate a deep but linear CNN in PSNR performance, and the additional nonlinearity may be necessary for the superior perceptual quality of nonlinear transform coding.

### Ablation Studies

The analysis transform—We ablate on the choice of analysis transform for our proposed two-layer synthesis architecture. Replacing the analysis transform of ELIC with that of Mean-Scale Hyperprior results in over 6% worse bitrate (with BPG as the anchor). This gap can be reduced to ~5% by increasing the number of base channels in the CNN analysis, although with diminishing returns and becomes suboptimal compared to switching to the ELIC analysis transform, as further described below.

Two-layer synthesis architecture—In some embodiments, an exhaustive architecture search may be conducted to identify various advantages and disadvantages of particular architectures. In some embodiments, hyperparameters may also be manually set.

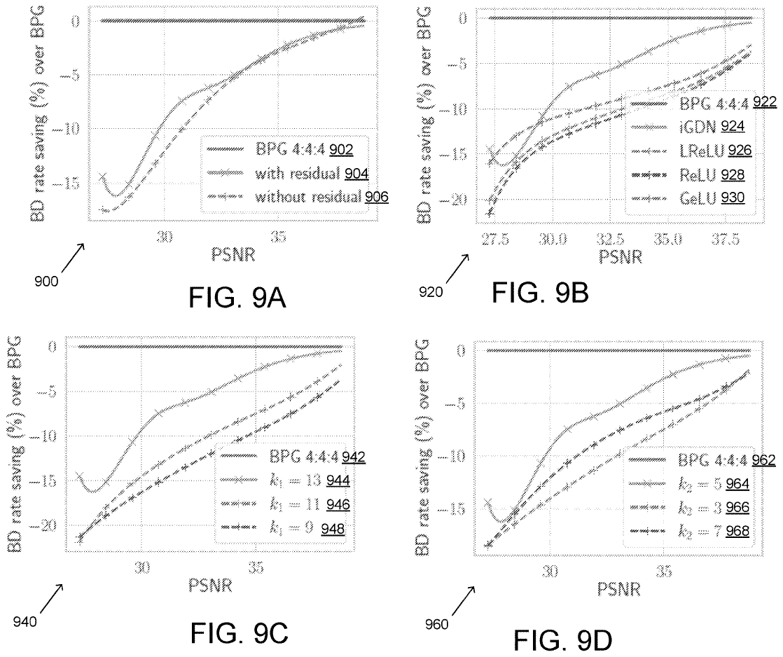

Diagrams illustrating ablation on various architectural choices of the proposed two-layer synthesis transform in accordance with an embodiment of the invention. BD-rate savings are evaluated on Kodak (the higher the better). FIG. 9A is a diagram 900 illustrating the results for the two-layered synthesis transform with residual connection 904 and without residual connection 906, and BPG 902 in accordance with an embodiment of the invention. FIG. 9B is a diagram 920 illustrating the results for BPG 902, iGDN (inverse GDN) 924, LReLU 926, ReLU 928, and GeLU 930 in accordance with an embodiment of the invention. FIG. 9C is a diagram 940 illustrating the results for the two-layered synthesis transform with hidden layer kernel sizes k₁=9 948, k₁=11 946, k₁=13 944, and BPG 942 in accordance with an embodiment of the invention. FIG. 9D is a diagram 960 illustrating the results for the two-layered synthesis transform with output layer kernel sizes k₂=7 968, k₂=3 966, k₂=5 964, and BPG 962 in accordance with an embodiment of the invention. FIGS. 9A-D present ablation results on the main architectural elements of the proposed two-layer synthesis. We found that the residual connection slightly improves the R-D performance at low bit-rates, compared to a simple two-layer architecture with comparable FLOPs (using 2N=24 hidden channels). We also found the use of (inverse) GDN activation and increased kernel size in the output layer (k₂) to be beneficial, which only cost a minor (less than 5%) increase in FLOPs. The number of channels (N) and kernel size (k₁) in the hidden layer are more critical in the trade-off between decoding FLOPs and R-D performance.

Although specific experiments, results, and insights for asymmetrically-powered neural image compression are discussed above with respect to FIGS. 5-9, any of a variety of experiments of asymmetrically-powered neural image compression as appropriate to the requirements of a specific application can be utilized in accordance with embodiments of the invention. Some general discussions of asymmetrically-powered neural image compression with shallow decoders in accordance with embodiments of the invention are further described below.

### Discussions

The present embodiments take steps toward closing the enormous gap between the decoding complexity of neural and traditional image compression methods. In many embodiments, the present embodiments exploit the often asymmetrical computation budget of encoding and decoding: by pairing a lightweight decoder with a powerful encoder, we can obtain high R-D performance while enjoying low decoding complexity. We formalize this intuition theoretically, and show that the encoding procedure affects the R-D cost of lossy compression via an inference gap, and more powerful encoders improve R-D performance by reducing this gap. In various implementation, the present embodiments adopt shallow decoding transforms inspired by classical codecs such as JPEG and JPEG 2000, while employing more sophisticated encoding methods including iterative inference. Empirically, we show that by pairing a powerful encoder with a shallow decoding transform, the resulting method achieves R-D performance competitive with BPG and the base Mean-Scale Hyperprior architecture, while reducing the complexity of the synthesis transform by over an order of magnitude. In several embodiments, the synthesis complexity may be further reduced by going beyond the transposed convolutions described above, e.g., via sub-pixel convolution or (transposed) depthwise convolution, as well as by exploiting the sparsity of the transform coefficients especially at low bit-rates (e.g., by performing the synthesis transform using sparse matrix operations).

The success of nonlinear transform coding over traditional transform coding can be mostly attributed to (1) data-adaptive transforms and (2) expressive deep entropy models. The present embodiments may provide improvements on the R-D-Compute efficiency of the synthesis transform, given that it accounts for the vast majority of decoding complexity in existing approaches, and may leave the hyperprior unchanged. As a result, entropy decoding (via the hyper-synthesis transform) may take up a majority (50%-80%) of the overall decoding computation in accordance with embodiments of the invention. Interestingly, we note that related work on flat manifolds found it necessary to use an expressive prior to learn a distance-preserving decoding transform, and recent work in video compression also features a simplified transform in the data space and a more expressive and computationally expensive entropy model. Given recent advances in computationally efficient entropy models, the entropy decoders in accordance with embodiments of the invention may be improved in rate-distortion-complexity.

In some embodiments, a limitation of a shallow synthesis is its worse performance on perceptual distortion compared to deeper architectures. The discussion above focused on the MSE distortion as in traditional transform coding; in this setting, it is known that an orthogonal linear transform gives optimal R-D performance for Gaussian-distributed data. However, the distribution of natural images is far from Gaussian, and compression methods are increasingly evaluated on perceptual metrics such as MS-SSIM both factors motivating the use of nonlinear transforms. The present embodiments may utilize insights from signal processing and deep generative modeling to produce more efficient nonlinear transforms with high perceptual quality, or an efficient pipeline based on a cheap MSE-optimized reconstruction followed by generative artifact removal/denoising for good perceptual quality. Additional details on the two-layer synthesis with residual connection in accordance with embodiments of the invention are further described below.

Details on the Two-Layer Synthesis with Residual Connection

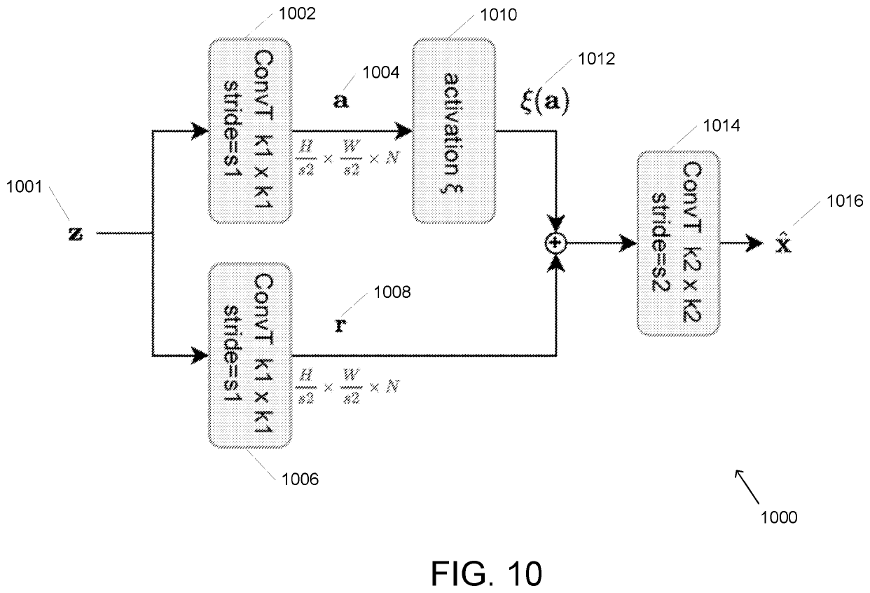

A diagram illustrating the proposed two-layer synthesis transform in accordance with an embodiment of the invention is shown in FIG. 10. Diagram 1000 illustrates the proposed two-layer architecture with a residual connection, with an input latent tensor z 1001 and output x 1016. Diagram 1000 also illustrates a=conv_1(z) 1004 that denotes the output of the first transposed conv layer 1002 (may also be referred to as “conv_1”). We implement the residual connection (the lower computation path in FIG. 10) with another transposed convolution layer 1006 (may also be referred to as “conv_res”). In many embodiments, the transposed convolution layer 1006 may be implemented using the same configuration (stride, kernel size, etc.) as the first transposed conv layer 1002. In various embodiments, the second layer may be implemented with a second transposed conv layer 1014 (may also be referred to as “conv_2”). In our main experiments we use k₁=13, s₁=8, k₂=5, s₂=2, and N=12.

In reference to FIG. 10, ξ 1010 may denote a nonlinear activation. The residual connection r 1008 is inspired by its success in recent NTC architectures, and can also be interpreted as a data-dependent and spatially-varying bias term that modulates the nonlinear activation ((a) 1012. At lower bit-rates, we found employing the residual connection to be more parameter- and compute-efficient than a simple composition of two transposed convolution layers without the residual connection. As described above, given a latent tensor z∈R^{h,w,C} the output may be given by g(z)=conv_2(ξ(conv_1(z))+conv_res(z)), where ξ is a nonlinear activation.

In further experiments, we re-trained models with “mixed quantization” instead of additive uniform noise as described above, and found that with comparable decoding complexity, a simple two-layer architecture with N=24 hidden channels (and no residual connection) in fact slightly outperforms the one with residual connection and N=12, while keeping all other hyperparameters the same.

Although specific details on two-layer synthesis using residual connection are discussed above with respect to FIG. 10, any of a variety of two-layer synthesis using various types of convolution, activation, or residual connection (or lack thereof) as appropriate to the requirements of a specific application can be utilized in accordance with embodiments of the invention. Theoretical results of asymmetrically-powered neural image compression with shallow decoders in accordance with embodiments of the invention are further described below.

### Theoretical Results

In the following, we derive the decomposition of the R-D cost of neural lossy compression. To lighten notation, we use non-bold letters (x, z instead of x, z), and adopt the general setting where the latent space Z is a Polish space (which includes, among many other examples, the Euclidean space commonly used for continuous latent variables, or an integer lattice in nonlinear transform coding), and P_{Z} is a prior probability measure. We present results in terms of measures for generality, but for readers unfamiliar with measure theory it is harmless to focus on the common case where P_{Z} admits a density p(z) (denoted p(z) above), s.t., P_{Z}(dz)=p(z)dz; in the discrete case, p(z) is a PMF, and the integral (w.r.t. the counting measure on Z) reduces to a sum. Similarly, Q_{Z|X} is family of probability measures, such that for each value of x it defines a conditional distribution Q_{Z|X}_{_{z}}, which may admit a density q(z|x).

A (learned) lossy compression codec may include a prior distribution P_{Z}, a stochastic encoding transform Q_{Z|X}, and a deterministic decoding transform g:Z→\hat{X}. Suppose relative entropy coding operates with minimal overhead, i.e., a sample from Q_{Z|X}_{₌ₓ} can be transmitted under P_{Z} with a bit-rate close to KL(Q_{Z|X}_{₌ₓ}∥P_{Z}) (which may require us to perform block coding), then given a data realization x, the rate-distortion compression cost is, on average,

$$ℒ ( {Q}_{Z \vert X} , g , {P}_{Z} , x ) := {λ𝔼}_{z ∼ {Q}_{Z \vert {X}_{= x}}} [ ρ ( x , g ( z ) ) ] + K L ( {Q}_{Z \vert {X}_{= x}} \vert \vert {P}_{Z} ) , \qquad ( 7 )$$

where ρ:X×\hat{X}→[0, ∞) is the distortion function, and λ≥0 is a fixed hyperparameter trading off between rate and distortion, and both p and A are specified by the lossy compression problem in advance.

In many embodiments, this compression cost admits a similar decomposition to the negative ELBO,

$$ℒ ( {Q}_{Z \vert X} , g , {P}_{Z} , x ) = - log {Γ}_{g , {P}_{Z}} ( x ) + K L ( {Q}_{Z \vert {X}_{= x}} \vert \vert {P}_{Z \vert {X}_{= x}} ) , \qquad ( 8 )$$

where P_{Z|X} denotes the Markov kernel (transitional distribution) defined by

$${P}_{Z \vert {X}_{= x}} ( dz ) := \frac{{e}^{- λρ ( x , g ( z ) )} {P}_{Z} ( dz )}{{Γ}_{g , {P}_{Z}} ( x )} , \qquad ( 9 )$$

and the normalizing constant is

$${Γ}_{g , {P}_{Z}} ( x ) := {\int }_{Z} {e}^{- λρ ( x , g ( z ) )} {P}_{Z} ( dz ) . \qquad ( 10 )$$

As in variational Bayesian inference, the normalizing constant has the interpretation of a marginal log-likelihood specified by the prior P_{Z} and model g. We note that the definition of P_{Z|X} depends on g and P_{Z}, but leave this out to lighten notation. Eq. 8 together with the non-negativity of KL divergence imply that P_{Z|X} is the optimal channel (“inference distribution”) for reverse channel coding, under which the compression cost equals:

$${min}_{{Q}_{Z \vert {X}_{= x}}} {λ𝔼}_{z \sim {Q}_{Z \vert {X}_{= x}}} [ ρ ( x , g ( z ) ) ] + K L ( {Q}_{Z \vert {X}_{= x}} \vert \vert {P}_{Z} ) = - log {Γ}_{g , {P}_{Z}} ( x ) \qquad ( 11 )$$

Let P_{X} be the data distribution. Taking the expected value of Eq. 8 w.r.t. x~P_{X} gives the population-level compression cost, which can then be rewritten as follows

$$ℒ ( {Q}_{Z \vert X} , g , {P}_{Z} ) := {λ𝔼}_{{P}_{X} {Q}_{Z \vert X}} [ ρ ( X , g ( Z ) ) ] + {𝔼}_{x \sim {P}_{X}} [ K L ( {Q}_{Z \vert {X}_{= x}} \vert \vert {P}_{Z} ) ] \qquad ( 12 )$$

$$= {𝔼}_{x \sim {P}_{X}} [ - log {Γ}_{g , {P}_{Z}} ( x ) ] + {𝔼}_{x \sim {P}_{X}} [ K L ( {Q}_{Z \vert {X}_{= x}} \vert \vert {P}_{Z \vert {X}_{= x}} ) ] \qquad ( 13 )$$

$$= {inf}_{{P}_{Z}^{′} , ω} {𝔼}_{x \sim {P}_{X}} [ - log {Γ}_{ω , {P}_{Z}^{′}} ( x ) ] + ( {E}_{x \sim {P}_{X}} [ - log {Γ}_{g , {P}_{Z}} ( x ) ] - {inf}_{{P}_{Z}^{′} , ω} {𝔼}_{x \sim {P}_{X}} [ - log {Γ}_{ω , {P}_{Z}^{′}} ( x ) ] ) \qquad ( 14 )$$

$$\begin{matrix}+ {𝔼}_{x \sim {P}_{X}} [ K L ( {Q}_{Z \vert {X}_{= x}} \vert \vert {P}_{Z \vert {X}_{= x}} ) ] & ( 15 )\end{matrix}$$

$$= {inf}_{ωϵ𝒢} {F}_{ω} ( λ ) + {\underbrace{( {𝔼}_{x \sim {P}_{X}} [ - log {Γ}_{g , {P}_{Z}} ( x ) ] - {inf}_{ωϵ𝒢} {F}_{ω} ( λ ) )}}_{modeling gap} + {\underbrace{{𝔼}_{x \sim {P}_{X}} [ K L ( {Q}_{Z \vert {X}_{= x}} \vert \vert {P}_{Z \vert {X}_{= x}} ) ]}}_{inference gap} . \qquad ( 16 )$$

where for any choice of decoder fucntion ω∈G, we define

$${F}_{ω} ( λ ) := {inf}_{{Q}_{Z \vert X}} I ( X ; Z ) + λ𝔼 [ ρ ( X , ω ( Z ) ) ] \qquad ( 17 )$$

as the R-axis intercept of the line tangent to the ω-dependent rate-distortion function with slope −λ. The last equation follows from Eq. 11 and the following calculation

$${inf}_{{P}_{Z}^{′} , ω} {𝔼}_{x \sim {P}_{X}} [ - log {Γ}_{ω , {P}_{Z}^{′}} ( x ) ] \qquad ( 18 )$$

$$= {inf}_{{P}_{Z}^{′} , ω} {inf}_{{Q}_{Z \vert X}} {λ𝔼}_{{P}_{X} {Q}_{Z \vert X}} [ ρ ( X , ω ( Z ) ) ] + {𝔼}_{x \sim {P}_{X}} [ K L ( {Q}_{Z \vert {X}_{= x}} \vert \vert {P}_{Z}^{′} ) ] \qquad ( 19 )$$

$$= {inf}_{ω} {inf}_{{Q}_{Z \vert X}} {inf}_{{P}_{Z}^{′}} {λ𝔼}_{{P}_{X} {Q}_{Z \vert X}} [ ρ ( X , ω ( Z ) ) ] + {𝔼}_{x \sim {P}_{X}} [ K L ( {Q}_{Z \vert {X}_{= x}} \vert \vert {P}_{Z}^{′} ) ] \qquad ( 20 )$$

$$= {inf}_{ω} {inf}_{{Q}_{Z \vert X}} {λ𝔼}_{{P}_{X} {Q}_{Z \vert X}} [ ρ ( X , ω ( Z ) ) ] + {inf}_{{P}_{Z}^{′}} {𝔼}_{x \sim {P}_{X}} [ K L ( {Q}_{Z \vert {X}_{= x}} \vert \vert {P}_{Z}^{′} ) ] \qquad ( 21 )$$

$$= {inf}_{ω} {inf}_{{Q}_{Z \vert X}} {λ𝔼}_{{P}_{X} {Q}_{Z \vert X}} [ ρ ( X , ω ( Z ) ) ] + I ( {P}_{X} {Q}_{Z \vert X} ) \qquad ( 22 )$$

$$= {inf}_{ω} {F}_{ω} ( λ ) \qquad ( 23 )$$

To summarize, we have broken down the R-D cost for a data source P_{X} into three terms,

$$ℒ ( {Q}_{Z \vert X} , ω , {P}_{Z} ) = {inf}_{ωϵ𝒢} {F}_{ω} ( λ ) + {\underbrace{( {𝔼}_{x \sim {P}_{X}} [ - log {Γ}_{g , {P}_{Z}} ( x ) ] - {inf}_{ωϵ𝒢} {F}_{ω} ( λ ) )}}_{modeling gap} + {\underbrace{{𝔼}_{x \sim {P}_{X}} [ K L ( {Q}_{Z \vert {X}_{= x}} \vert \vert {P}_{Z \vert {X}_{= x}} ) ]}}_{inference gap} . \qquad ( 24 )$$

The first term (which we denoted by the shorthand “F(G)” in the main text) represents the fundamentally irreducible cost of compression determined by the source P_{X} and the family G of decoding transforms used. This is the information-theoretically optimal cost of compression within the transform family G. If we let F(λ):=inf_{Q\hat{x}|x}I(X; \hat{X})+λE[ρ(X;\hat{X})] be the optimal Lagrangian associated with the R-D function of P_{X}, then it can be shown that F(λ)≤F_{g}(λ). When the latent space Z and the transform family are sufficiently large, it holds that F(λ)=inf_{g}F_{g}(λ), i.e., the first term of the R-D cost is determined solely by the rate-distortion function of the source distribution P_{X} (and distortion function φ, which is the lossy analogue of the Shannon entropy.
The second term represents the excess cost of doing compression with a particular transform g and prior P_{z} compared to the best possible transform and prior, while always operating with the optimal channel (Eq. 8) in each case. Note that this term only depends on the modeling choices of g and P_{z}, and does not depend on the encoding/inference distribution Q_{Z|X}; therefore we call it the modeling gap. It is due largely to imperfect model training/optimization, and/or a mismatch between the training data and the target data P_{X} (which may not be the same).
The third term represents the overhead of compression caused by a (potentially) sub-optimal encoding/inference distribution Q_{Z|X}, given a particular model g and P_{z}. This overhead can be eliminated by using the optimal channel P_{Z|X} given in Eq. 8 (which depends on g and P_{z}). Therefore, we call this term the inference gap.

Remarks—The decomposition of the lossy compression cost has a natural parallel to that of lossless compression under a latent variable model.

Consider a latent variable model (p_{θ}(z),p_{θ}(x|z)) with parameter vector θ, which defines a model of the marginal data density p_{θ}(z):=∫_{z} p_{θ}(x|z)p_{θ}(z)dz. The cost of lossless compression under ideal bits-back coding is equal to the negative ELBO, and admits a similar decomposition:

$${𝔼}_{x \sim {P}_{X}} [ {𝔼}_{z \sim q ( z \vert x )} [ - log {p}_{θ} ( x \vert z ) ] + K L ( q ( z \vert x ) \vert \vert {p}_{θ} ( z ) ) ] \qquad ( 25 )$$

$$= {𝔼}_{x \sim {P}_{X}} [ - log {p}_{θ} ( x ) ] + {𝔼}_{x \sim {P}_{X}} [ K L ( q ( z \vert x ) \vert \vert {p}_{θ} ( z \vert x ) ) ] \qquad ( 26 )$$

$$= {\underbrace{H [ {P}_{X} ]}}_{data entropy} + {\underbrace{K L ( {P}_{X} \vert \vert {p}_{θ} ( x ) )}}_{modeling gap} + {\underbrace{{𝔼}_{x \sim {P}_{X}} [ K L ( q ( z \vert x ) \vert \vert {p}_{θ} ( z \vert x ) ) ]}}_{inference gap} \qquad ( 27 )$$

Again, we have decomposed the compression cost into a first term that represents the intrinsic compressibility of the data, a second term that depends entirely on the choice of the model, and a third overhead term from using a sub-optimal inference distribution q(z|x) and which can be eliminated using the optimal inference distribution p_{θ}(z|x)∝p_{θ}(x|z)p_{θ}(z) (the Bayesian posterior) given each choice of our model. Implementation and reproducibility of asymmetrically-powered neural image compression with shallow decoders in accordance with embodiments of the invention are further described below.

### Implementation and Reproducibility Details

In various embodiments, the models described herein may be implemented in tensorflow using the tensorflow-compression library. For example, we implemented the Mean-Scale Hyperprior model based on the open source code and various architecture details. We borrowed the ELIC transforms from the VCT repo.

In several embodiments, our experiments were run on Titan RTX GPUs. All the models were trained with the Adam optimizer following standard procedure for a maximum of 2 million steps. We use an initial learning rate of 1e-4, then decay it to 1e-5 towards the end of training. For each model architecture, we trained separate models for A E {0.00125, 0.0025, 0.005, 0.01, 0.02, 0.04, 0.08}. For SGA, we use similar hyperparameters, using Adam optimizer, learning rate 5e−3, and a temperature schedule of T(t)=0.5exp{-0.0005((0, t−200))} for 3000 gradient steps. Additional results and considerations in accordance with embodiments of the invention are further described below.

### Additional Results

### Results on the Reconstruction Manifold

In a variety of embodiments, we train three popular NTC architectures for MSE distortion with λ=0.08 and observe similar results when traversing the manifold of reconstructed images. We use random pairs of image crops from COCO to define the start and end points of latent traversal (as further described above) and we use the same random seed across the three different architectures. All the images are scaled to [−0.5, 0.5].

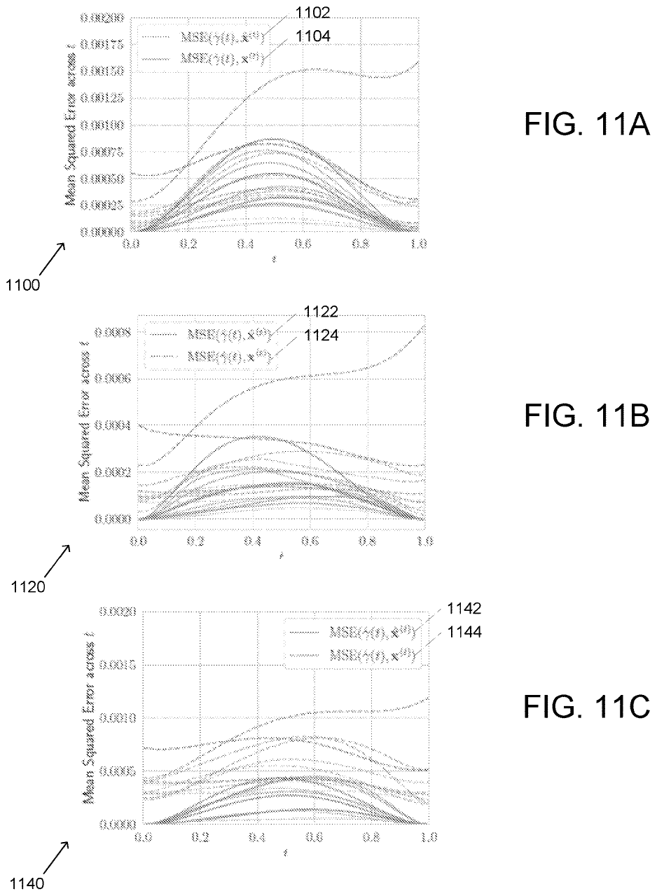

MSEs between trajectories—Diagrams illustrating the distance from the trajectory of decoded curve \hat{γ}(t) to the straight path between end-point reconstructions \hat{x}^{(t)}:=(1−t)\hat{x}⁽⁰⁾+t\hat{x}⁽¹⁾, and the distance from the trajectory of decoded curve \hat{γ}(t) to the straight path between ground truth images x^{(t)}:=(1−t)x⁽⁰⁾+tx⁽¹⁾ in accordance with an embodiment of the invention is shown in FIGS. 11A-C. In FIG. 11A, diagram 1100 illustrates the distance 1102 from the trajectory of decoded curve \hat{γ}(t) to the straight path between end-point reconstructions \hat{x}^{(t)}:=(1−t)\hat{x}⁽⁰⁾+t\hat{x}⁽¹⁾, and the distance 1104 from the trajectory of decoded curve \hat{γ}(t) to the straight path between ground truth images x^{(t)}:=(1−t)x⁽⁰⁾+tx⁽¹⁾ in Factorized Prior. In FIG. 11B, diagram 1120 illustrates the distance 1122 from the trajectory of decoded curve \hat{γ}(t) to the straight path between end-point reconstructions \hat{x}^{(t)}:=(1−t)\hat{x}⁽⁰⁾+t\hat{x}⁽¹⁾, and the distance 1124 from the trajectory of decoded curve \hat{γ}(t) to the straight path between ground truth images x^{(t)}: (1−t)x⁽⁰⁾+tx⁽¹⁾ in Mean-Scale Hyperprior. In FIG. 11C, diagram 1140 illustrates the distance 1142 from the trajectory of decoded curve \hat{γ}(t) to the straight path between end-point reconstructions \hat{x}^{(t)}:=(1−t)\hat{x}⁽⁰⁾+t\hat{x}⁽¹⁾, and the distance 1144 from the trajectory of decoded curve \hat{γ}(t) to the straight path between ground truth images x^{(t)}:=(1−t)x⁽⁰⁾+tx⁽¹⁾ in Channel-wise Autoregressive. The resulting curves from the different nonlinear transform coding methods exhibit similar behavior, varying smoothly with t. See detailed discussions above in reference to FIG. 4A.

Quantifying the curvature of decoded curves of reconstructions—Additionally, we quantify how much the curves of reconstructed images deviate from straight paths by computing the curve lengths. Recall given two tensors of latent coefficients (z⁽⁰⁾, z⁽¹⁾) (obtained by passing two images (x⁽⁰⁾, x⁽¹⁾) through the analysis transform), we let γ: [0, 1]→Z be the straight line in the latent space defined by their convex combination, i.e., γ(t):=(1−t)z⁽⁰⁾+tz⁽¹⁾ The curve of reconstructions is then defined by \hat{γ}(t):=g(γ(t)), with end-points x⁽⁰⁾:=g(z⁽⁰⁾) and \hat{x}⁽¹⁾:=g(z⁽¹⁾).

The curve length of \hat{γ} may be given by

$$L ( \hat{γ} ) := {\int }_{0}^{1} ‖ \frac{\partial g ( γ ( t ) )}{\partial t} ‖ dt = {\int }_{0}^{1} ‖ \frac{\partial g ( γ ( t ) )}{\partial γ ( t )} \frac{\partial γ ( t )}{\partial t} ‖ dt = {\int }_{0}^{1} ‖ {J}_{t} v ‖ dt = {\int }_{0}^{1} \sqrt{{v}^{T} {J}_{t}^{T} {J}_{t} v} dt \qquad ( 28 )$$

Where J t is the Jacobian of the synthesis transform evaluated at z^{(t)}=γ(t), and

$$v = \frac{{\partial }_{γ} t}{\partial t} = {z}^{1} - {z}^{0}$$

is the (constant) curve velocity. We compute this integral approximately with a Riemann sum.

The shortest path (in Euclidean geometry) between the two end-points of \hat{γ} is given simply by the linear interpolation (1−t)\hat{x}⁽⁰⁾+t\hat{x}⁽¹⁾, with a distance of ∥\hat{x}⁽¹⁾+\hat{x}⁽⁰⁾∥. Therefore, we define the curve-to-shortest-path length ratio

$$η := \frac{L ( \hat{γ} )}{‖ {\hat{x}}^{( 1 )} - {\hat{x}}^{( 0 )} ‖} \qquad ( 29 )$$

as a measure of how much the curve\hat{ }γdeviates from a straight path, with η=1 indicating a completely straight line.

We compute the curve-to-shortest-path-length ratio η on 50 randomly chosen image pairs in three NTC architectures We use random 16×16 image crops (the results are similar for larger images) from COCO. We compute the curve length integral in Eq. 28 via a Riemann sum,

$$\frac{1}{T} {\sum }_{{t}_{1}} ‖ {J}_{{t}_{1}} ( {z}^{( 1 )} - {z}^{( 0 )} ‖ with T = 100 .$$

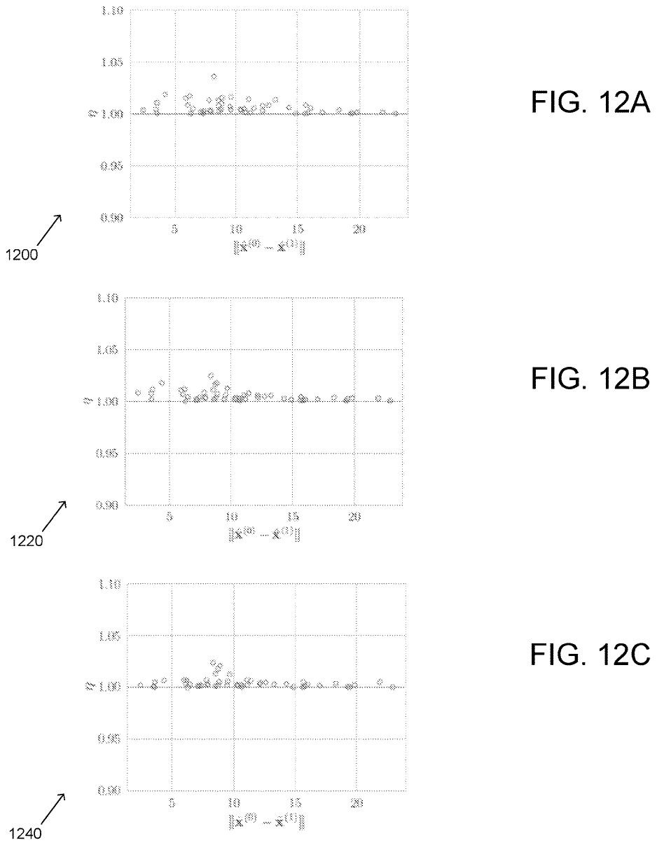

Diagrams illustrating curve-length ratio η vs. the straight-path-length for randomly chosen image pairs, in three different nonlinear transform coding architectures in accordance with an embodiment of the invention is shown in FIGS. 12A-C. FIGS. 12A-C plot the resulting η values against the straight-path lengths. In FIG. 12A, diagram 1200 illustrates curve-length ratio η vs. the straight-path-length for randomly chosen image pairs in Factorized Prior. In FIG. 12B, diagram 1220 illustrates curve-length ratio η vs. the straight-path-length for randomly chosen image pairs in Mean-Sale Hyperprior. In FIG. 12C, diagram 1240 illustrates curve-length ratio η vs. the straight-path-length for randomly chosen image pairs in Channel-wise Autoregressive. In all cases, the curve lengths are close to the straight-path lengths (η concentrated near 1), and this property appears to hold globally across randomly chosen image pairs.

### Visualizing the Filters of Synthesis Transforms

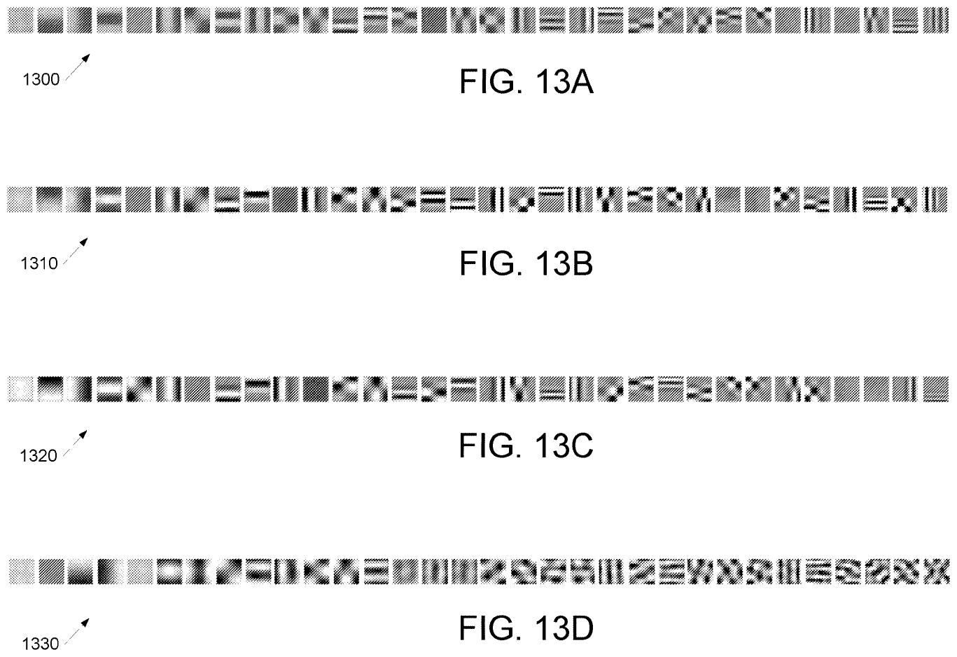

Diagrams illustrating visualization of learned filters in various neural compression methods with varying synthesis transform complexity in accordance with an embodiment of the invention is shown in FIGS. 13A-D. In FIG. 13A, diagram 1300 provides a visualization of the learned filters (i.e., top 20 filters) of the base Mean-Scale Hyperprior architecture. In FIG. 13B, diagram 1310 provides a visualization of the learned filters (i.e., top 20 filters) of the two-layer synthesis model. In FIG. 13C, diagram 1320 provides a visualization of the learned filters (i.e., top 20 filters) of the JPEG-like synthesis model. In FIG. 13D, diagram 1330 provides a visualization of the top 20 PCA components learned on 10000 random 16×16 color image patches from COCO.

For the neural compression methods, we visualize the synthesis filters corresponding to the 20 latent channels with the highest bit-rates on average (as determined on a small batch of validation images); following prior work, we produce the visualization for channel i as follows: let e be a ‘basis’ tensor of shape [1, 1, C] (unit width/height) consisting of zeros except the ith channel, which equals 1; let 0 be a tensor of zeros with the same shape as e; then the impulse response associated with channel i is computed as g(δe)−g(0), where δ is a scaling factor which affects the color intensity when visualized. This results in a 16×16 colored image patch. We manually set a different δ for each architecture to result in a roughly comparable range of displayed colors, with δ∈[8,20]. We also apply a scaling factor when visualizing the principal components from PCA.

### Ablation Results

The analysis transform—Here, we examine how different choices of the analysis transform affect the performance of our method based on the two-layer synthesis transform and ELIC's analysis transform.

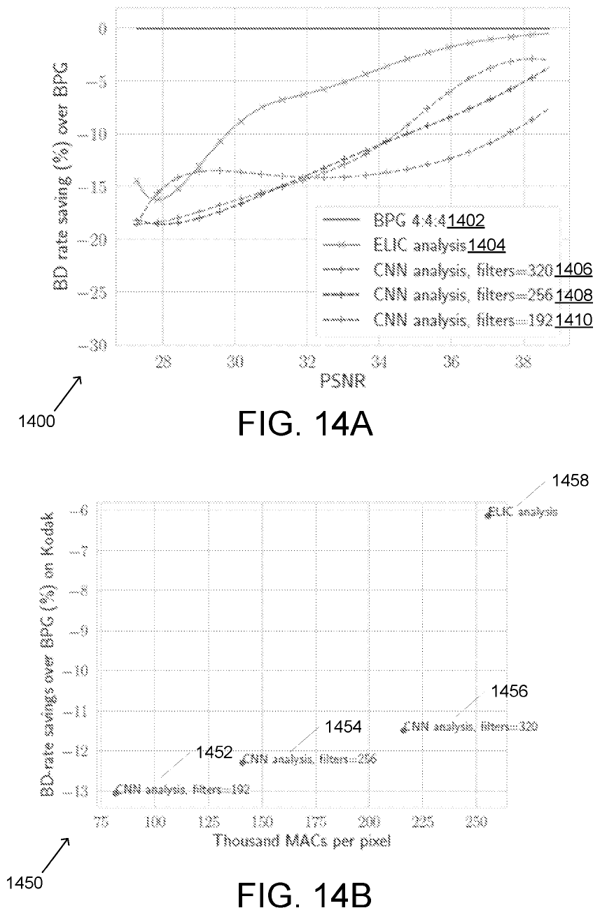

We adopt the simpler CNN analysis transform from Mean-Scale Hyperprior, which consists of 4 layers of convolutions with F=192 filters each, except for the last layer which outputs C=320 channels for the latent tensor. FIGS. 14A-B show the resulting performance with varying F, in both BD-rate savings as well as computational complexity. Specifically, diagrams illustrating ablation results on the choice of analysis transform in the proposed two-layer synthesis architecture in accordance with an embodiment of the invention is shown in FIGS. 14A-B. In FIG. 14A, diagram 1400 shows BD-rate savings over BPG on Kodak for various analysis transforms including BPG 1402, ELIC analysis 1404, CNN analysis, filters=320 1406, CNN analysis, filters=256 1408, and CNN analysis, filters=192 1410. In FIG. 14B, diagram 1450 shows aggregate BD-rate savings on Kodak, vs. analysis transform complexity, measured in KMACs per pixel for CNN analysis, filters=192 1452, CNN analysis, filters=256 1454, CNN analysis, filters=320 1456, and ELIC analysis 1458. We see that the CNN analysis gave worse performance than ELIC analysis, and the gap can be closed to some extent by increasing F, but with diminishing returns and increasingly high encoding complexity.

Additional investigations—We present results giving additional insight into the present embodiments and how it compares to alternatives, evaluated on Kodak.

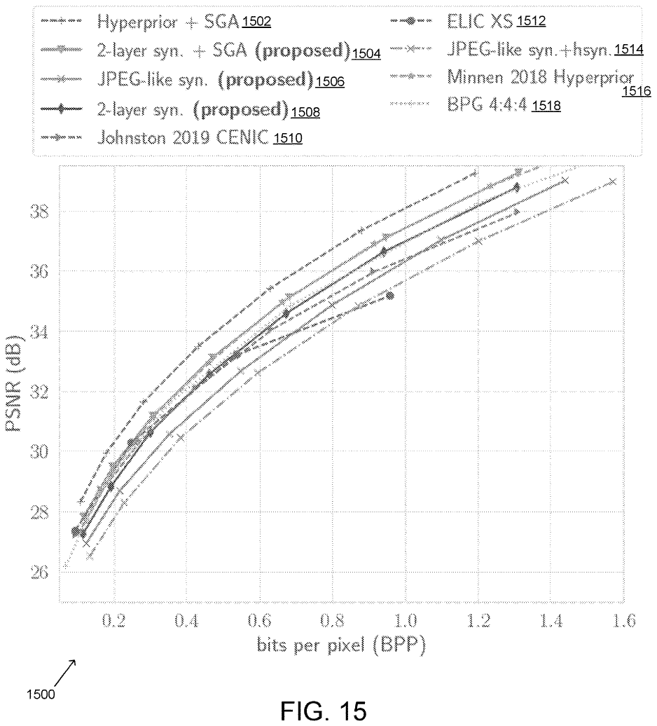

A diagram illustrating miscellaneous additional results in accordance with an embodiment of the invention is shown in FIG. 15. First, we consider also applying SGA to the Hyperprior baseline (curve 1502), this also results in a sizable boost in R-D, even larger than what we observe for our more shallow decoders. We hypothesize that this may be caused by a relatively larger inference gap in the Hyperprior architecture than ours with shallow decoders. Next, we show that simply scaling down existing neural compression models tends to result in worse performance than our approach. We consider two existing architectures: the mean-scale Hyperprior (curve 1516) and ELIC, and slim down their synthesis transforms to match (to our best ability) the FLOPs of our two-layer shallow synthesis (curve 1504). For Hyperprior, we adopt a pruned synthesis transform given by CENIC (specifically, we use their architecture #178, which uses about 7.3 KMACs/pixel, or about 1.4 times of our two-layer synthesis; we keep the hyper synthesis intact). For ELIC, we simply reduce the number of conv channels in the synthesis to be 32, so that it uses about 16.5 KMACs/pixel (we also keep its hyper synthesis intact). We train the resulting architectures from scratch; as shown by the curve 1510 (“Johnston 2019 CENIC”) and curve 1512 (“ELIC XS”), this results in progressively worse R-D performance in the higher-rate regime compared to our two-layer synthesis (curve 1508).

Finally, we conduct a preliminary exploration of a JPEG-like architecture for the hyper synthesis transform (curve 1514). We implement this with a single transposed-conv layer with stride 4 and (6, 6) kernels. We applied it on top of our linear JPEG-like synthesis (curve 1506), and observe a 10% worse BD-rate (curve 1506→curve 1514) but nearly a 10-fold reduction in the hyper synthesis FLOPs (15.18→1.8 KMACs/pixel). In addition, results for BPG (curve 1518) are also provided in diagram 1500.

### Additional R-D Results

Below we include aggregate R-D results on the 100 test images from Tecnick and 41 images from the professional validation set of CLIC 2018. We additionally evaluate on the perceptual distortion LPIPS.

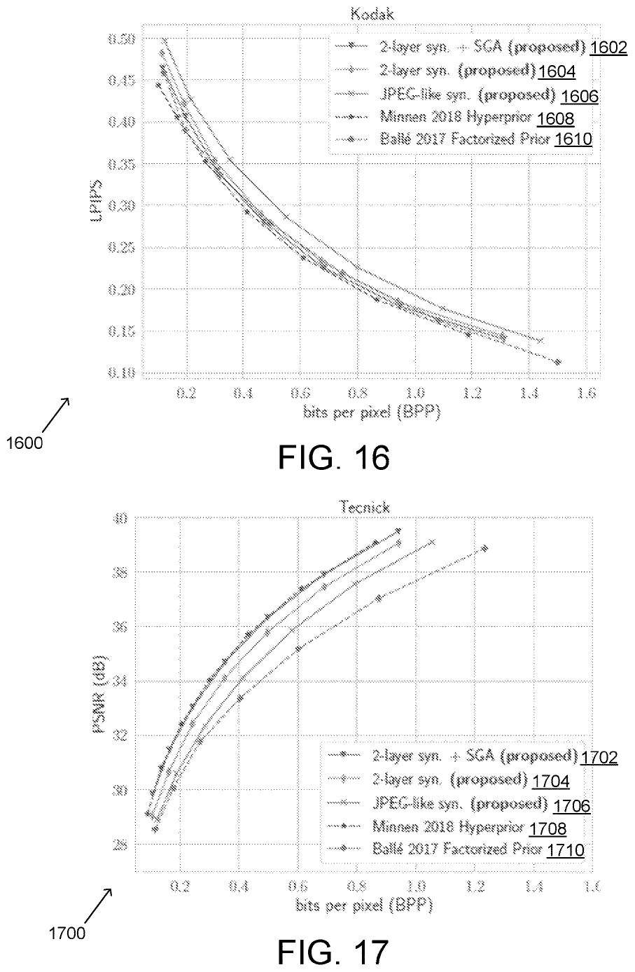

A diagram illustrating aggregate LPIPS vs. BPP performance on Kodak in accordance with an embodiment of the invention is shown in FIG. 16. Diagram 1600 provides results for two-layer synthesis+SGA 1602, two-layer synthesis 1604, JPEG-like synthesis 1606, Minnen 2018 Hyperprior 1608, and Ballè 2017 Factorized Prior 1610.

A diagram illustrating aggregate PSNR vs. BPP performance on Tecnick in accordance with an embodiment of the invention is shown in FIG. 17. Diagram 1700 provides results for two-layer synthesis+SGA 1702, two-layer synthesis 1704, JPEG-like synthesis 1706, Minnen 2018 Hyperprior 1708, and Ballè 2017 Factorized Prior 1710.

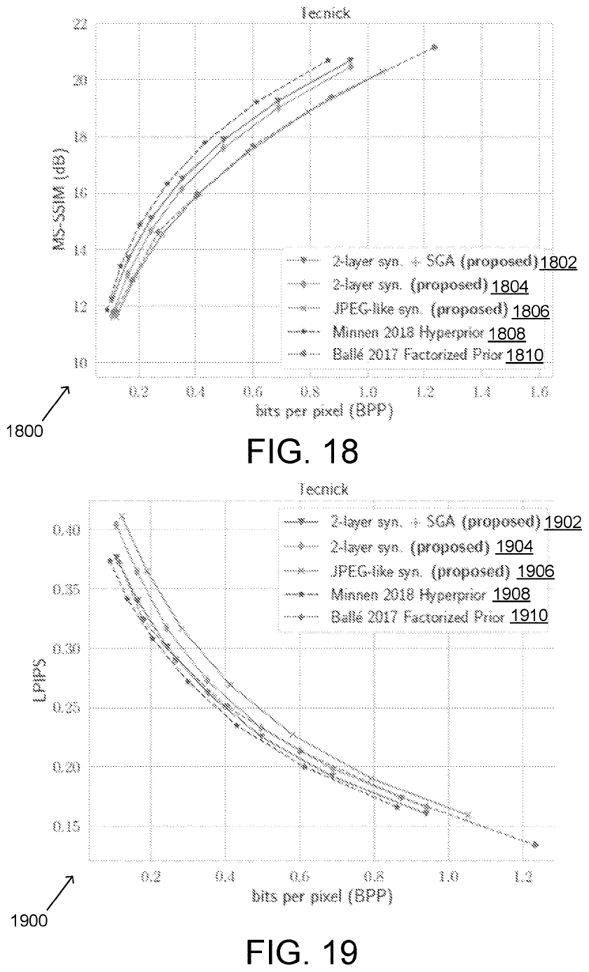

A diagram illustrating aggregate MS-SSIM vs. BPP performance on Tecnick in accordance with an embodiment of the invention in FIG. 18. Diagram 1800 provides results for two-layer synthesis+SGA 1802, two-layer synthesis 1804, JPEG-like synthesis 1806, Minnen 2018 Hyperprior 1808, and Ballè 2017 Factorized Prior 1810.

A diagram illustrating aggregate LPIPS vs. BPP performance on Tecnick in accordance with an embodiment of the invention is shown in FIG. 19. Diagram 1900 provides results for two-layer synthesis+SGA 1902, two-layer synthesis 1904, JPEG-like synthesis 1906, Minnen 2018 Hyperprior 1908, and Ballè 2017 Factorized Prior 1910.

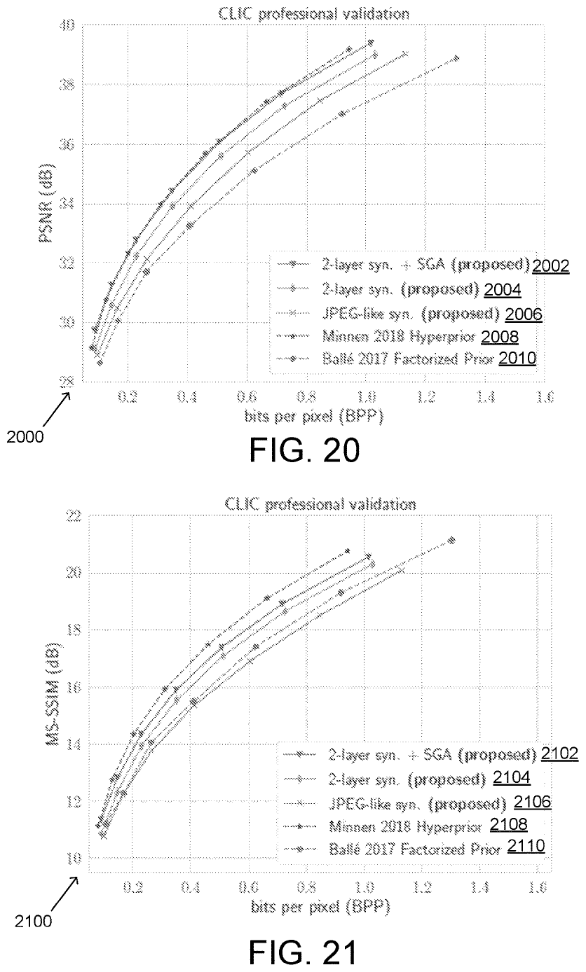

A diagram illustrating aggregate PSNR vs. BPP performance on CLIC professional validation set in accordance with an embodiment of the invention is shown in FIG. 20. Diagram 2000 provides results for two-layer synthesis+SGA 2002, two-layer synthesis 2004, JPEG-like synthesis 2006, Minnen 2018 Hyperprior 2008, and Ballè 2017 Factorized Prior 2010.

A diagram illustrating aggregate MS-SSIM vs. BPP performance on CLIC professional validation set in accordance with an embodiment of the invention is shown in FIG. 21. Diagram 2100 provides results for two-layer synthesis+SGA 2102, two-layer synthesis 2104, JPEG-like synthesis 2106, Minnen 2018 Hyperprior 2108, and Ballè 2017 Factorized Prior 2110.

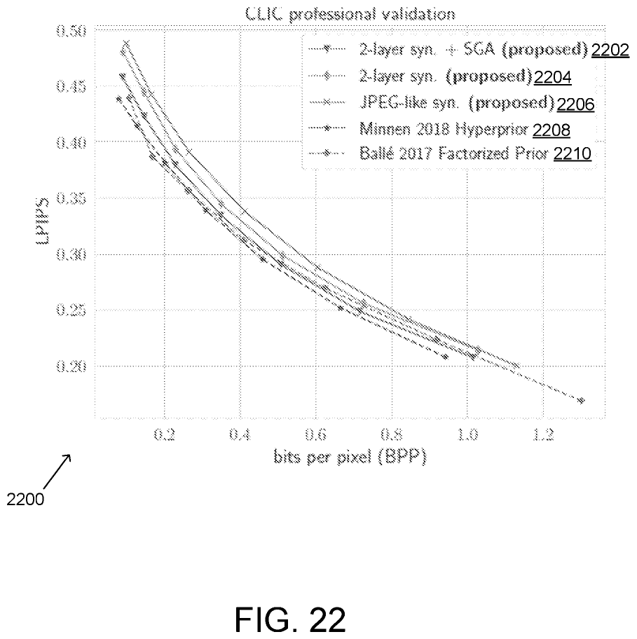

A diagram illustrating aggregate LPIPS vs. BPP performance on CLIC professional validation set in accordance with an embodiment of the invention is shown in FIG. 22. Diagram 2200 provides results for two-layer synthesis+SGA 2202, two-layer synthesis 2204, JPEG-like synthesis 2206, Minnen 2018 Hyperprior 2208, and Ballè 2017 Factorized Prior 2210.

Overall, we observe that our proposed two-layer synthesis with iterative encoding matches the Hyperprior performance when evaluated on PSNR, but under-performs by 8%-12% (in BD-rate) when evaluated on perceptual metrics such as MS-SSIM or LPIPS. This is consistent with results on Kodak, as further described above.

Although experiments, results, and insights for asymmetrically-powered neural image compression with shallow decoders discussed above with respect to FIGS. 11-22, any of a variety of experiments, results, and insights as appropriate to the requirements of a specific application can be utilized in accordance with embodiments of the invention. For example, various R-D results may be further improved by utilizing different encoding (analysis) transforms and/or using modifications to the training procedures in accordance with embodiments of the invention. Example systems for asymmetrically-powered neural image compression with shallow decoders in accordance with embodiments of the invention are further described below.

### Example Asymmetrically-Powered Neural Image Compression Systems

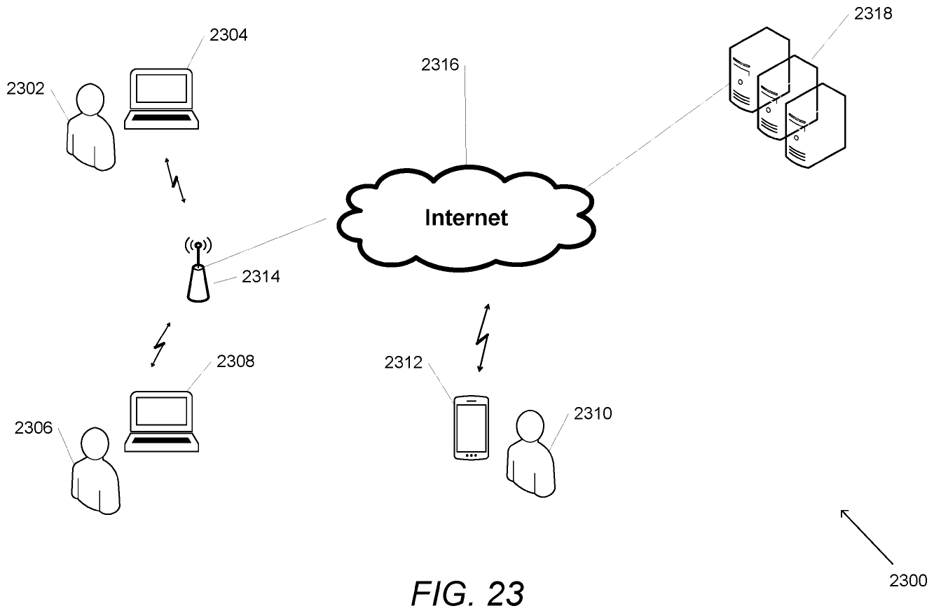

As described above, many systems may have an asymmetrical computation budget with greater budget for encoding over decoding. A system diagram illustrating asymmetrically-powered neural image compression with shallow decoders in accordance with an embodiment of the invention is shown in FIG. 23. An asymmetrically-powered neural image compression system 2300 may include a first client 2302 on a first client device 2304 and a second client 2306 on a second client device 2308. In various embodiments, the system 100 may also include additional clients on additional client devices, such as, but not limited to, a third client 2310 on a third client device 2312. In various embodiments, the system 2300 may include any number of clients each having their own client device. In some embodiments, one or more clients may share a single client device. In some embodiments, the client device(s) 2304, 2308, 2312 may include, but is not limited to, a desktop computer, a laptop computer, a tablet computer, a smart phone, etc.

In reference to FIG. 23, the system 2300 may include one or more servers 2318 configured to receive and/or generate data (may also be referred to as “source data”), compress the source data (may also be referred to as “encoded data”) using various encoding methods, as further described above. For example, in some embodiments, the server(s) 2318 may be content providers that transmit (e.g., stream) content to client devices. In many embodiments, the server(s) 2318 may include encoder(s) (implemented as hardware or by software) that perform encoding methods, as further described above. For example, the server(s) 2318 may implement the ELIC analysis transform and/or iterative encoding using SGA, as further described above. In several embodiments, the client device(s) 2304, 2308, 2312 may include various electronic devices that may allow users (may also be referred to as “clients”) to receive encoded data and perform decoding of the encoded data to generate decoded data, as further described above. For example, the client device(s) 2304, 2308, 2312 may include shallow decoders (implemented as hardware or by software) that perform decoding of encoded data using various methods, such as, but not limited to, two-layered nonlinear synthesis, JPEG-like synthesis, etc., as further described above. In many embodiments, “source data” may refer to any data before it is encoded by the encoder including data that has or has not previously been compressed. Further, “encoded data” may refer to any data after it has been encoded by the encoder. In addition, “decoded data” may refer to any data after it has been decoded by the shallow decoder.

In reference to FIG. 23, the client devices 2304, 2308, 2312 and the server(s) 2318 may be connected to and have access to the Internet 2316 in a manner known to one of ordinary skill in the art. For example, the client devices 2304, 2308, 2312 and the server(s) 2318 may access the Internet 2316 using a variety of methods such as, but not limited to, by using a modem and/or router (and/or using a wireless access point). For example, the first client device 2304 and the second client device 2308 may access the Internet 2316 via a wireless access point 2314, such as, but not limited to, Wi-Fi. Further, the third client device 2312 may access the Internet 2316 using a cellular network. In some embodiments, the client devices 2304, 2308, 2312 and/or the server(s) 2318 may have dedicated access to the Internet 2316.

Although specific asymmetrically-powered neural image compression systems including specific devices are illustrated in FIG. 23, any number of systems and devices as appropriate to the requirements of a specific application may be utilized in accordance with embodiments of the invention. For example, encoding may be performed on client devices and decoding may be performed at other devices such as, but not limited to, other client devices, servers, etc. Further, any type of data may be compressed and image data is described above as one example. Example apparatus and processes for asymmetrically-powered neural image compression systems in accordance with embodiments of the invention are discussed further below.

### Apparatus and Processes for Asymmetrically-Powered Neural Image Compression Systems

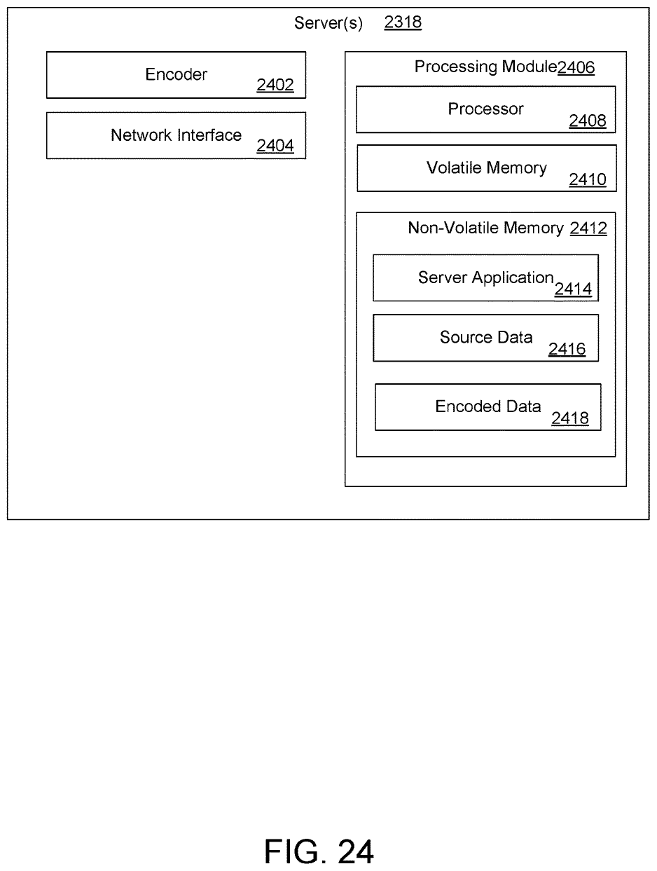

Various devices may be used in asymmetrically-powered neural image compression systems. A block diagram illustrating server(s) 2318 for asymmetrically-powered neural image compression in accordance with an embodiment of the invention is shown in FIG. 24. The server(s) 2318 may include an encoder 2402 and a network interface 2404. The server(s) 2318 may also include a processing module 2406 that includes a processor 2408, a volatile memory 2410, and a non-volatile memory 2412. In some embodiments, the non-volatile memory 2412 may include a server application 2414 that configures the processor 2408 to receive source data 2416 using the network interface 2404. In some embodiments, the server application may configure the processor 2408 to generate the source data 2416. In many embodiments, the server application 2414 may configure the processor 2408 to generate encoded data 2418 by performing one or more encoding methods on the source data 2416, as further described above.

In reference to FIG. 24, the various components, including (but not limited to) the processing module 2406, are represented by separate boxes. The graphical representations depicted in FIG. 24 are merely examples and are not intended to indicate that any of the various components of the server(s) 2318 are necessarily physically separate from one another, although in some embodiments they might be. In some embodiments, however, the structure and/or functionality of any or all components of the server(s) 2318 may be combined. The volatile memory 2410 may include, but is not limited to, Randomly Accessed Memory (RAM) or another comparable form of rapid storage. Non-volatile memory 2412 may include, but are not limited to, any memory type that retains storage of data after powering down. In addition, in some embodiments the network interface 2404 and/or encoder 2402 may include its own processor, volatile memory, and/or non-volatile memory. In some embodiments, the encoder 2402 may be implemented in hardware or using code by the server(s) 2318. For example, the server application 2414 may configure the processor 2408 to perform and/or implement one or more encoding methods, as further described above. In addition, the network interface 2404 may comprise, but is not limited to, one or more transceivers and/or wireless antennas (not shown) configured to transmit and receive wireless signals such as (but not limited to) satellite, radio frequency (RF), Bluetooth or WIFI. In other embodiments, the network interface 2404 may comprise (but is not limited to) one or more transceivers configured to transmit and receive wired signals.

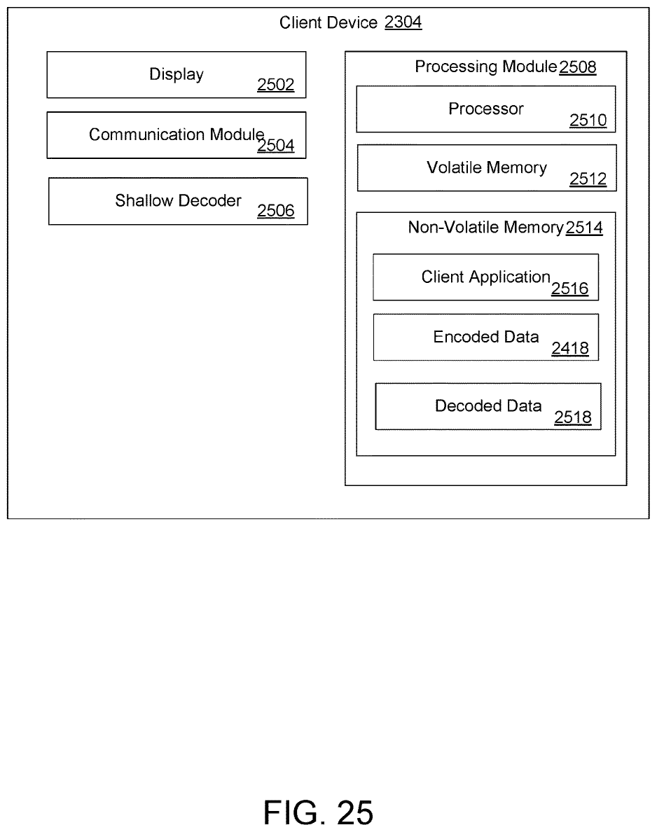

A block diagram illustrating an example client device (e.g., a first client device 2304, second client device 2308, or a third client device 2312) in accordance with an embodiment of the invention is shown in FIG. 25. As illustrated, the first client device 2304 may include a display 2502, a communication module 2504, and a shallow decoder 2506. In some embodiments, the display 2502 may be separate standalone devices from the first client device 2304. For example, in some embodiments, the first client device 2312 may be a desktop computer configured to connect to a display 2502. In some embodiments, the first client device 2312 may be a laptop computer, smart-phone, tablet, etc., that includes a built-in display 2502.

In reference to FIG. 25, the first client device 2304 may also include a processing module 2508 that may include a processor 2510, a volatile memory 2512, and a non-volatile memory 2514. In various embodiments, the non-volatile memory 2514 may include a client application 2516 that configures the first client device 2304 to receive encoded data 2418, using the communication module 2504, from the server(s) 2304. In many embodiments, the client application 2516 may configure the processor 2510 to generate decoded data 2518 by performing one or more decoding methods on the encoded data 2418, as further described above.

In reference to FIG. 25, the various components including (but not limited to) the processing module 2508 are represented by separate boxes. The graphical representations depicted in FIG. 25 are merely examples and are not intended to indicate that any of the various components of the first client device 2304 are necessarily physically separate from one another, although in some embodiments they might be. In some embodiments, however, the structure and/or functionality of any or all components of the first client device 2304 may be combined. In some embodiments, the processor 2510 may include, but is not limited to, any generic processing unit capable of performing computations. The volatile memory 2512 may include, but is not limited to, Randomly Accessed Memory (RAM) or another comparable form of rapid storage. Non-volatile memory 2514 may include, but are not limited to, any memory type that retains storage of data after powering down. Further, the communication module 2504 and/or shallow decoder 2506 may include their own processors, volatile memories, and/or non-volatile memories. In some embodiments, the decoder 2506 may be implemented in hardware or using code by the client device 2304. For example, the client application 2514 may configure the processor 2510 to perform and/or implement one or more decoding methods, as further described above. In addition, the communication module 2504 may comprise, but are not limited to, one or more transceivers and/or wireless antennas (not shown) configured to transmit and receive wireless signals such as (but not limited to) satellite, radio frequency (RF), Bluetooth or WIFI. In other embodiments, the communication module 2504 may comprise (but are not limited to) one or more transceivers configured to transmit and receive wired signals.

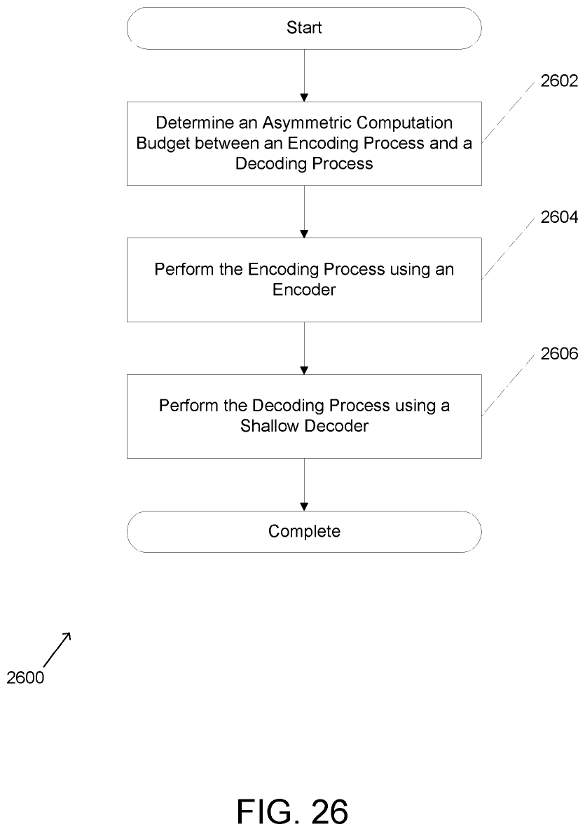

A process for asymmetrically-powered neural image compression with shallow decoders in accordance with an embodiment of the invention is illustrated in FIG. 26. The process 2600 may include determining (2602) an asymmetric computation budget between an encoding process and a decoding process. In many embodiments, the asymmetric computation budget includes an encoding computation budget that is greater than a decoding computation budget. In some embodiments, the encoding and decoding computation budgets may be measured in computational complexity (e.g., KMACs per pixel or FLOPs). In various embodiments, the encoding computation budget may be much greater than the decoding computation budget. For example, some examples are provided above and also in Table 1 reproduced above. In some embodiments, encoding computation budget may be multiples greater than the decoding computation budget (e.g., 45×, 35×, 25×, 10×, etc.).

In reference to FIG. 26, the process 2600 may also include performing (2604) the encoding process using an encoder, as further described above. For example, in many embodiments, the encoding process may include generating encoded data from a source data using an analysis transform or an iterative optimization process, as further described above. In addition, the process 2600 may also include performing (2606) the decoding process using a shallow decoder, as further described above. For example, in various embodiments, the decoding process may include generating decoded data from the encoded data using a synthesis transform such as, but not limited to, a two-layer nonlinear synthesis transform, a JPEG-like synthesis transform, etc., as further described above.

Although specific apparatus (e.g., specific servers and client devices) and processes are illustrated in FIG. 24-26, any number of apparatus and processes as appropriate to the requirements of a specific application may be utilized in accordance with embodiments of the invention.

Each of these non-limiting examples can stand on its own or can be combined in various permutations or combinations with one or more of the other examples. The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” In this document, the term “set” or “a set of” a particular item is used to refer to one or more than one of the particular item.

Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A method for an asymmetrically-powered neural image compression with shallow decoders, the method comprising:
determining an asymmetric computation budget between an encoding process and a decoding process, wherein the asymmetric computation budget comprises an encoding computation budget that is greater than a decoding computation budget,
performing the encoding process using an encoder, wherein the encoding process comprises generating encoded data from a source data using an analysis transform; and
performing the decoding process using a shallow decoder, wherein the decoding process comprises generating decoded data from the encoded data using a synthesis transform.

2. The method of claim 1, wherein the encoding and decoding computation budgets are measured in computational complexity.

3. The method of claim 2, wherein the computational complexity is measured using thousand multiply-accumulate operations (“KMACs”) per pixel.

4. The method of claim 2, wherein the computational complexity is measured by a number of floating point operations (“FLOPs”).

5. The method of claim 1, wherein the encoding computation budget is at least forty-five times greater than the decoding computation budget.

6. The method of claim 1, wherein the encoding computation budget is at least thirty-five times greater than the decoding computation budget.

7. The method of claim 1, wherein the encoding computation budget is at least twenty-five times greater than the decoding computation budget.

8. The method of claim 1, wherein the encoding computation budget is at least ten times greater than the decoding computation budget.

9. The method of claim 1, wherein the encoding process is selected based on the encoding computation budget and a predetermined rate-distortion (“R-D”) performance.

10. The method of claim 1, wherein the decoding process is selected based on the decoding computation budget and the predetermined R-D performance.

11. The method of claim 1, wherein the encoding process comprises generating encoded data from the source data using an iterative optimization process.

12. The method of claim 1, wherein the analysis transform is a neural image compression analysis transform.

13. The method of claim 12, wherein the encoding process further comprises iterative encoding.

14. The method of claim 13, wherein the iterative encoding is Stochastic Gumbel Annealing (“SGA”).

15. The method of claim 1, wherein the synthesis transform is a two-layer nonlinear synthesis transform.

16. The method of claim 15, wherein the two-layer nonlinear synthesis transform comprises:
a first transposed convolution layer having a convolution kernel size parameter (k₁), an upsampling stride parameter (s₁), and N output channels;
an optional residential connection comprising a residual convolution transposed layer; and
a second transposed convolution layer having a convolution kernel size parameter (k₂), an upsampling stride parameter (s₂), and a number of output channels specified by that of an image being reconstructed.

17. The method of claim 16, wherein the residual convolution transposed layer is implemented with same k₁, s₁, and N parameters as the first transposed convolution layer.

18. The method of claim 17, wherein a nonlinear activation is applied to an output of the first transposed convolution layer.

19. The method of claim 18, wherein the decoding computation budget remains low by selecting the k₁ to be greater than the k₂, and selecting the s₁ to be greater than the s₂.

20. The method of claim 19, wherein k₁=13, s₁=8, k₂=5, s₂=2, N=12, and a residual connection is used and configured with the same parameters.

21. The method of claim 19, wherein k₁=13, s₁=8, k₂=5, s₂=2, N=24, and no residual connection is used.

22. The method of claim 1, wherein the synthesis transform is a JPEG-like synthesis transform.

23. The method of claim 22, wherein the encoded data comprises a latent tensor of coefficients as in nonlinear transform coding, and the JPEG-like synthesis transform interprets the encoded data as coefficients of a linear synthesis transform and outputs decoded data in blocks.

24. The method of claim 23, wherein a (i,j)th block in the decoded data is computed as a linear combination of learned basis images functions weighted by a vector of encoded coefficients associated with a (i,j)th spatial location.

25. The method of claim 24, wherein the JPEG-like synthesis transform comprises overlapping basis functions with spatial extent k×k, where k≥s and k−s is a number of overlapping pixels, and basis functions are learned from data examples as in nonlinear transform coding.

26. The method of claim 25, wherein the JPEG-like synthesis further generates the decoded data using a sum of overlapping blocks.

27. The method of claim 26, wherein the output of the JPEG-like synthesis is computed by a transposed convolution operation with a kernel size parameter (k), and an upsampling stride parameter (s), and a number of output channels specified by that of the image being reconstructed.

28. The method of claim 27, wherein the image being reconstructed is an RBG image and the number of output channels equals 3.
